(19) United States
(12) Patent Application Publication
(10) Pub. No.: US 2010/0009860 A1
(43) Pub. Date: Jan. 14, 2010

(54) Device and method for analysis of interactions between biomolecules

(76) Inventors: Gunter Fischer, Halle (DE); Cordelia Schiene-Fischer, Halle (DE); Miroslav Malesevic, Halle (DE); Mike Schutkowski, Waldesruh/OT Dahlwitz-Hoppegarten (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/631,680

(22) PCT Filed: Jul. 7, 2005
(86) PCT No.: PCT/EP2005/007366

§ 371 Date: Jul. 9, 2007

(30) Foreign Application Priority Data
Jul. 8, 2004 (DE) 10 2004 033 122.7

(51) Int. Cl. C40B 30/04; C40B 40/04; C40B 40/06; C40B 40/10; C40B 40/12

(52) U.S. Cl. 506/9; 506/15; 506/16; 506/18; 506/19

(57) ABSTRACT

The present invention relates to a device for the analysis of interactions between biomolecules comprising a support, on which a plurality of biomolecules are immobilized on the surface of a support material in a regular or irregular manner by a linker, whereby two biomolecules are bound to each linker. Further, the present invention relates to a method for the detection of interactions between biopolymers immobilized on a surface comprising the steps of providing a device of one of the preceding claims, adjusting a defined distance between two biopolymers immobilized on the surface and detection of a signal generated by the interaction between the two biopolymers.

The present invention relates to a device comprising a plurality of biomolecules assembled on a surface of substrates, whereby the biomolecules are immobilized pairwise with a distance from one another via a spacer on the surface. Further, the present invention relates to a method for the preparation of a device according to the invention and to a method for the detection of interactions between biomolecules.

For a comparative study of molecular recognition between biomolecules of the same or different classes of structures, the use of large combinatorial libraries of binding partners offered from solution is beneficial, whereby the binding partners are immobilized on a substrate.

A person skilled in the art understands the term “biomolecules” e.g. as compounds of the classes of nucleic acids and their derivatives, proteins, peptides and carbohydrates. These classes of compounds are referred to as “biopolymers” as well.

This principle of interacting molecular recognition is used particularly for the specific construction of polynucleotides from nucleoside units and/or oligonucleotide units. Again, the specific polynucleotide construction is of crucial importance for the preparation of DNA chips having a high density of assembled polynucleotides thereon.

DNA chips, i.e. so-called micro arrays of spots of immobilized DNA or arbitrary selected oligonucleotides on a glass or polymer substrate which function as super multiplex probes for the molecular recognition by hybridization (S. P. A. Fodor, Science 277 (1997) 393, DNA Sequencing Massively Parallel Genomics), are used already for a long time e.g. in medical or pharmaceutical research.

Besides nucleic acids, natural substances or libraries thereof, as well as arrays of oligopeptides and proteins are attached on such chips. Cellulose, glass, polypropylene, polyethylene, nitro cellulose, PTFE-membranes and special agar have been used as support materials besides the afore mentioned materials for these arrays.

Peptides and proteins become more and more important with the increasing importance of proteomics and their biotechnological uses. Generally, there are proteins enabling almost all biochemical reactions within and outside the cell. The use of arrays of nucleic acids detecting either the messenger-RNA (mRNA) generated by genes instantly active in the cell or DNA copies of this mRNA are of great importance, however, the information, which is available thereby, is for a serious of reasons not sufficient for an understanding of the mechanisms of both the intracellular and extracellular processes and for making use thereof in the areas of different biotechnological uses. One reason is that the amount of mRNA within the cell does often not correlate with the corresponding amount of protein produced in the cell. Furthermore, proteins as once produced are influenced in its biological function by small chemical modifications within the cell (post-translational modifications).

Thus, there is a need for a parallel analysis of binding properties of as many as possible proteins. Such an analysis allows inter alia the fast mapping of binding sites, which is again an important prerequisite for the design of knowledge-based inhibitors or for the selective examination of pharmaceuticals or candidates of pharmaceuticals or active agents.

It is state of the art to immobilize e.g, nucleic acids, peptides, or peptides on different surfaces such as e.g. glass (J. Robles et al; 1999, Tetrahedron, 55, 13251-13264), cellulose (D. R. Englebretsen, D. R. K. Harding; 1994, Pept. Res., 7, 322-326), nitrocellulose (S. J. Hawthorne, et al.; 1998, Anal. Biochem., 261, 131-138), PTFE membranes (T. G. Vargo et al.; 1995, J. Biomed. Mat. Res., 29, 767-778), titanium oxide (S. J. Xiaoet et al.; 1997, J. Materials Science-Materials in Medicine, 8, 867-872), silica (T. Koyano et al.; 1996, Biotech. Progress., 12, 141-144) or gold (B. T. Houseman, M. Meksich; 1998, J. Org. Chem., 63, 7552-7555) or directly on a correspondingly functionalized or non-functionalized glass surface (S. P. A. Fodor et al.; 1991, Science, 251, J. P. Pellois, W. Wang, X. L. Gao; 2000, J. Comb. Chem., 2, 355-360) or on cellulose (R. Frank, 1992, Tetrahedron, 48, 9217-9232; A. Kramer and J. Schneider-Mergener, Methods in Molecular Biology, Vol. 87; Combinatorial Peptide Library Protocols, page 25-39, edited by S. Cabilly; Humana Press Inc., Totowa, N.J.; Töpert, F. et al.; Angew. Chem. Int. Ed. 40, 897-900) or on polypropylene (M. Stankova et al.; 1994, Pept. Res., 7, 292-298, F. Rasoul et al.; 2000, Biopolymers, 55, 207-216, H. Wenschuh et al.; 2000, Biopolymers, 55, 188-206) or on chitin (W. Neugebauer et al.; 1996, Int. J. Pept. Prot. Res., 47, 269-275) or on sepharose (W. Tegge, R. Frank, 1997, J. Peptides Res., 49, 355-362, R. Gast; 1999, Anal. Biochem., 276, 227-241) and the stepwise synthesis of peptides is performed step-by-step.

However, a parallel analysis of interactions between different immobilized biopolymers or biopolymer sequences (vide infra), particularly of nucleic acids, carbohydrates, peptides, or proteins was up to now not successful.

The object of the present invention is the provision of means for the parallel detection of interactions between at least two different biopolymers such as e.g. peptides, nucleic acids (DNA, RNA, PLA, etc.), and their derivatives, whereby on the one hand these means are suitable to be used in a system with a high throughput and on the other hand requires only a small sample volume. It is particularly desired that such means, in contrast to means of the state of the art, need e.g. only information available from the sequence data bases for the mapping of protein-protein interactions.

A further object of the present invention is the provision of a method for detecting an interaction between a first immobilized biomolecule and another immobilized biomolecule or biopolymer, which is different from the first biomolecule, particularly an interaction between a biopolymer and another biopolymer, and further a method for the determination of the efficiency and selectivity of an active agent.

The problem underlying the invention is solved by a device for the analysis of interactions between biomolecules comprising a support on which a plurality of biomolecules are immobilized by a linker on the surface of the support material in a regular or irregular array, whereby two biomolecules are bound on each linker.

Preferably, the linker has an essentially forklike (Y-shaped) structure. The advantage of this Y-shaped structure allows that biomolecules may be placed in the immediate vicinity and in a specific and directed orientation on the surface, as well as that the biomolecules can be arranged in a defined distance to one another depending on the specific design of the Y-shaped structure (in the following “molecular fork”).

In a particularly preferred embodiment, the linker comprises three reactive groups and is covalently bound to the surface of the support via one of these reactive groups.

In a particularly preferred embodiment of the invention, the biomolecules are biopolymers consisting of regular or irregular sequences of monomer units. The advantage of this embodiment is the possibility to synthesize the biopolymers in-situ directly from monomer units bound to the surface.

Preferably, the biopolymers are selected from terpenes, nucleic acid sequences, carbohydrate sequences, amino acid sequences and peptide-glycoconjugate sequences.

Especially preferred is that the biopolymer sequences bound to a linker are arranged by means of a spacer such that a defined distance between them is maintained. The advantage of this embodiment allows for displacing biopolymer sequences by defined distances, since interactions depend on the correct distances of the involved chemical groups.

The material of the support is preferably selected from glass, ceramics, metals and their alloys, cellulose, chitin and synthetic polymers. The advantage of such support is i) supplying a rigid planar surface and ii) enabling chemical modification.

The problem of the present invention is further solved by a method for detecting interactions between biopolymers immobilized on a surface comprising the steps:
a) providing a device according to the invention,
b) adjusting a defined distance between two different biopolymers immobilized on the surface,
c) measuring signals generated by the interaction between the two different biopolymers.

A measurable signal is generated when at least two different immobilized biopolymers are approaching closely each other due to their interaction. In a preferred embodiment the detection of interactions is carried out on amino acid sequences. The advantage of this embodiment is the ability to detect protein-protein-interactions by said interactions, which are poorly accessible by other investigation methods.

In some embodiments the amino acid sequence is modified by fluorescent groups such as for example o-aminobenzoic acid or a fluoresceine group.

In a further embodiment, the detection of the interactions results from bringing in contact the device with a further molecule capable of distinguishing between interacting immobilized biopolymers and non-interacting immobilized biopolymers. The advantage of this embodiment is the fact that several different further molecules may be added subsequently such that the same array may be analysed by different detection methods.

In a further preferred embodiment, intended the detection of the interaction of immobilized biopolymers is carried out by a method showing the presence of the added molecules and which is selected from a group comprising autoradiography, plasmon-resonance spectroscopy, immunology and fluorescent spectroscopy. An advantage using such a method is that the interactions are detected quantitatively.

Moreover, in still a further advantageous embodiment, the detection of the interactions is performed directly by using a method of detection capable of distinguishing between interacting immobilized biopolymers, such as e.g. peptides, and non-interacting immobilized biopolymers such as e.g. peptides. The advantage of this direct detection of an interaction is the independency from further detecting agents which may interfere with an interaction.

In a further embodiment, a detection of the interaction is carried out using a detection method, whereby different signals result from different distances between interacting immobilized biopolymers and non-interacting immobilized biopolymers.

In yet a further preferred embodiment, the detection of the interaction of immobilized biopolymers is carried out by a method showing the change in distance, whereby the method is selected from the group comprising NMR-spectroscopy, electron-spin-resonance-spectroscopy, CD-spectroscopy, mass-spectrometry, ST-IR-spectroscopy and fluorescence-spectroscopy. An advantage in using such a method is that interactions are detected quantitatively.

In a further advantageous embodiment, the detection of the interaction is carried out by using a method of detection which results in different signals for interacting immobilized biopolymers and for non-interacting immobilized biopolymers after adding auxiliary agents preferably deuterated agents.

The detection of the interaction between immobilized biopolymers is further preferably carried out by a method which displays the change of the exchange rate of amide deuterones, whereby the method is selected from the group comprising MALDI mass-spectroscopy, ESI mass-spectroscopy and NMR-spectroscopy.

It is further preferred that the detection of the interaction between the immobilized biopolymers is carried out by a method, whereby amino acid sequence groups are irradiated with light of appropriate frequency and intensity which results in covalent bonds between the interacting amino acid sequences, and whereby the readout of the corresponding detection signal is selected from the group comprising MALDI mass-spectrometry, ESI mass-spectrometry and NMR-spectroscopy. The advantage of this embodiment is that an interaction is fixed in a stable manner by a covalent link and that this interaction is subsequently accessible for further methods of analysis which are specific for stably linked compounds.

In yet another embodiment of the method according to the invention, the device is brought in contact with an agent before the interaction of immobilized biopolymers is detected by one of the above-mentioned methods of detection.

Further, the device is brought in contact with an agent, which is selected from a group consisting of pharmaceutical agents, potential pharmaceutical agents, organic molecules and natural products. The advantage of this embodiment is the fact that a specific high throughput search for inhibitors active against interactions between biopolymers is possible even in the absence of both interacting partners in the substance.

The present invention is now explained in more detail by a non-limiting example, specifically a device having amino acid sequence groups immobilized on a surface preferably an amino acid sequence quartet and even more preferred an amino acid sequence pair,

It is understood that the following explanations apply to all afore mentioned biopolymers. This is particularly valid in case two different biopolymers, e.g. a nucleic acid sequence and an amino acid sequence, or a carbohydrate and a nucleic acid sequence or a nucleic acid sequence are bound to the so-called molecular fork of the invention in further preferred embodiments.

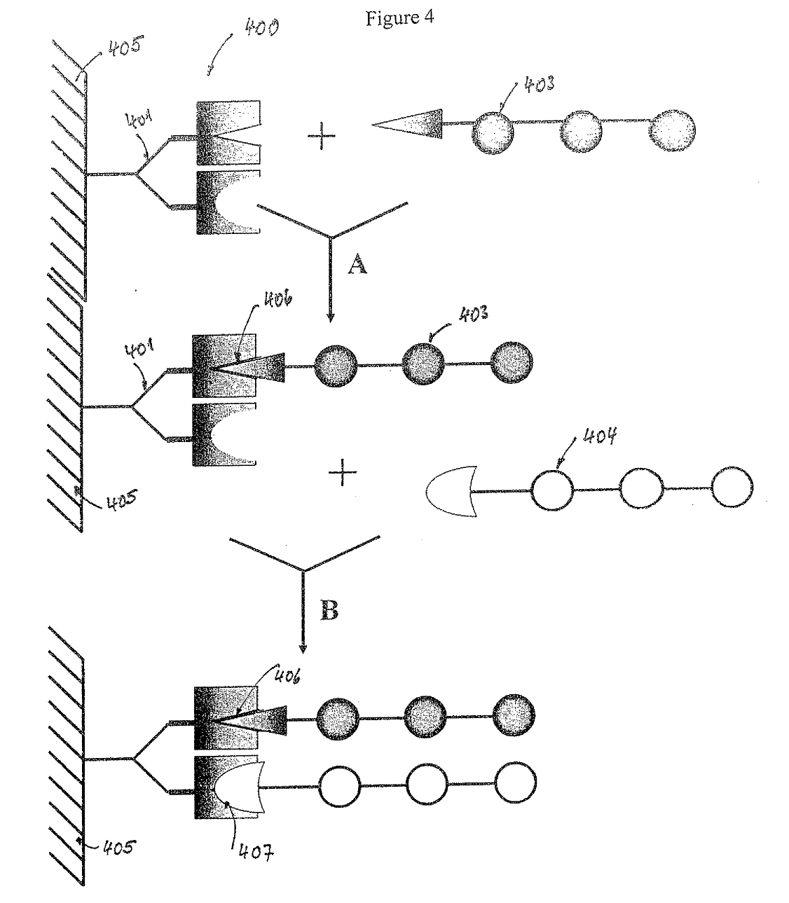

According to the invention the amino acid sequences are immobilized on a surface by a molecular fork according to the invention (see FIG. 4). Preferably the surface is a planar surface. Thus, interactions or binding events between two or more immobilized amino acid sequences are detected.

In other words, the array according to the invention allows surprisingly in the case of amino acid sequences the breakdown of a protein-protein-interaction into a plurality of peptide-peptide-interactions. It is especially beneficial that in a particular preferred embodiment in the case of the direct detection of interactions between amino acid sequences immobilized on a molecular fork, only the sequence information on two proteins is required instead of the proteins per se, in order to map the interacting surfaces or binding sites of both proteins.

In this case, the two interacting proteins A and B are decomposed into the corresponding peptides, particularly preferred into so-called overlapping peptides. All combinations, preferably binary combinations of the peptides derived from the proteins A and B, are applied subsequently directly or by immobilization on a correspondingly shaped molecular fork.

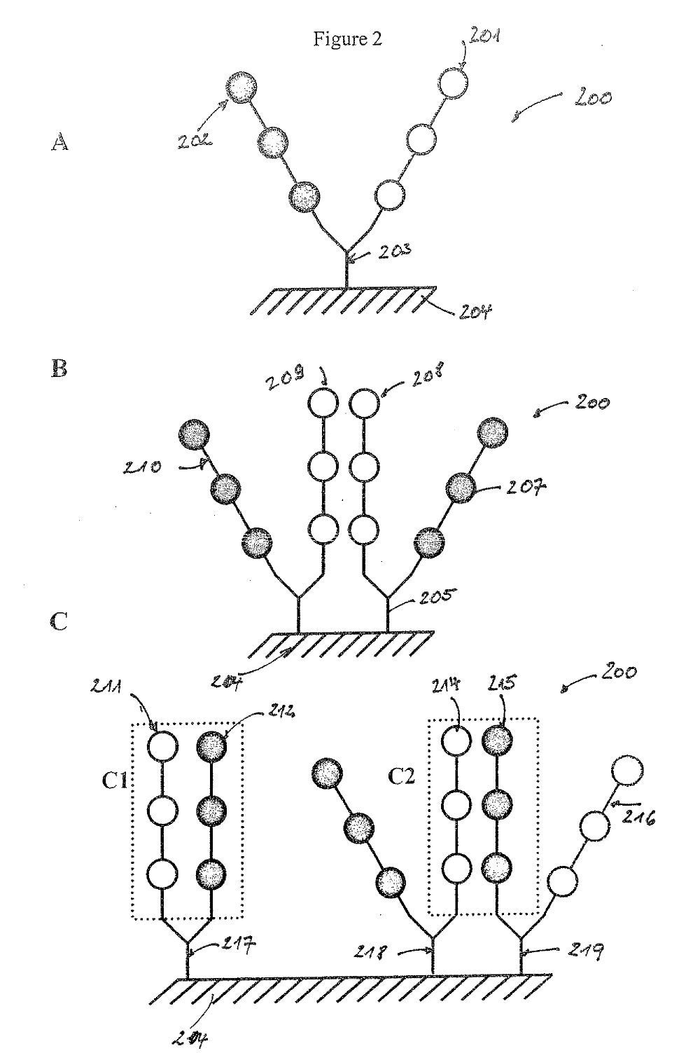

Besides the possibility that the peptides, which are immobilized on the molecular fork, do not interact with one another (FIG. 2A), there is the possibility of an intra-molecular interaction shown in FIGS. 2B and 2C. According to the invention only those interactions are of interest where biopolymer sequences immobilized either on one single molecular fork (FIG. 2C1) or on several different molecular forks (FIG. 2C2, shown for a binary molecular fork) interact with one another in a manner corresponding to the interactions of the respective native proteins.

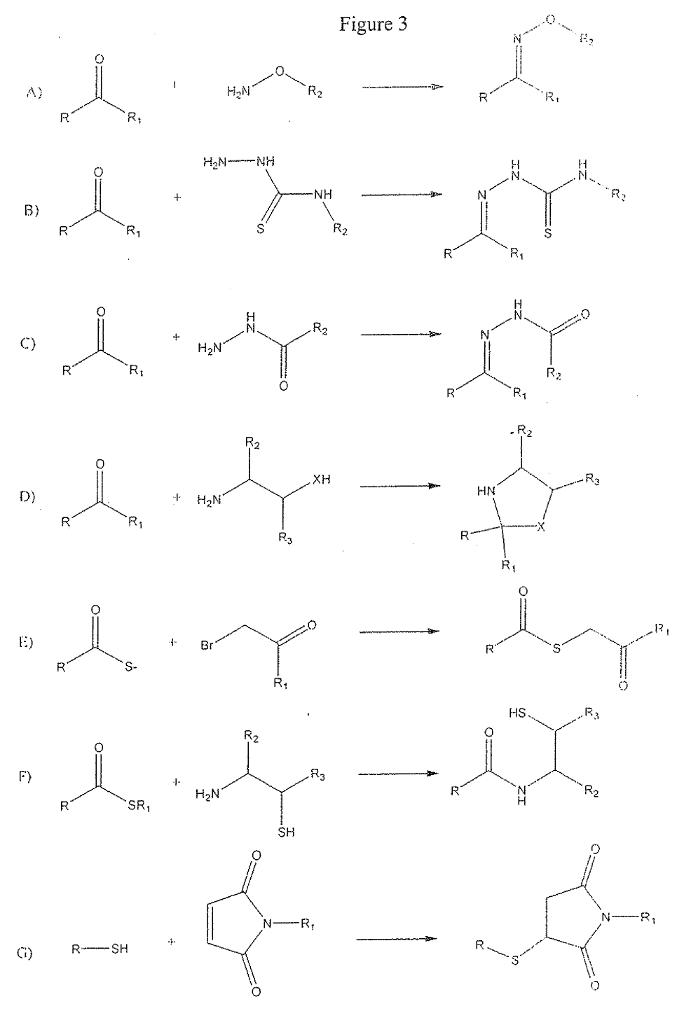

In the device according to the invention having a plurality of amino acid sequences deposited on a surface by molecular forks, the substrate where the plurality of amino acid sequence groups are immobilized is formed by said surface. Thereby, the immobilization is performed such that it is obtained by covalent bonds. Besides the covalent immobilization, there are, however, other forms of immobilization, particularly the immobilization by adsorption or the immobilization by specific systems of interactions. With regard to the form of immobilization, it is especially preferred that the immobilization is obtained by a covalent bond, where a chemo-selective binding of the amino acid sequence is obtained on the surface of the support material. For this purpose, numbers of reactions may be used, known by a skilled person in the art (Lemieux, G. A. & Bertozzi, C. R., 1998, TIBTECH, 16, 506-513, see FIG. 3).

Depending on the reaction conditions applied and in view of the required specific chemo-selective immobilization, it should generally be ensured that only one specific binding is formed between the amino acid sequences of the amino acid sequence groups and domains of the molecular fork on the surface (FIG. 4). Typically, amino or carboxyl groups within the amino acid sequence are not impaired during the chemo-selective reactions.

Examples for appropriate reactions are the formation of thioethers from halogenated carboxy acids and thiols, of thiolethers from thiols and maleic imides, of amide bindings from thioesters and 1,2-aminothiols, of thioamide bindings from dithioesters and 1,2-aminothiols, of thiazolidines from aldehydes and 1,2-aminothiols, of oxazolidines from aldehydes/ketones and 1,2-amino alcohols, of imidazoles from aldehydes/ketones and 1,2-diamines, (see FIG. 3 as well), of thiazoles from thioamides and halogenated alpha-ketones, of aminothiazoles from amino-oxy compounds and alpha-isothiocyanato ketones, of oximes from amino-oxy compounds and aldehydes, of oximes from amino-oxy compounds and ketones, of hydrazones from hydrazines and aldehydes, of hydrazones from hydrazides and ketones. Therein, the radicals R1-R5 shown in FIG. 3 or the radicals in the afore mentioned chemo-selective reactions may represent alkyl, alkenyl, alkinyl, cycloalkyl or aryl, or heterocycles, whereby alkyl represents branched or unbranched C₁₋₂₀-alkyl, C₃₋₂₀-cycloalkyl, preferably branched or unbranched C₁₋₁₂-alkyl, C₃₋₁₂-cycloalkyl and particularly preferred branched or unbranched C₁₋₆-alkyl, C₃₋₆-cycloalkyl. Alkenyl represents branched or unbranched C₂₋₂₀-alkenyl, branched or unbranched C₁₋₂₀-alkyl-O—C₂₋₂₀-alkenyl, C₁₋₂₀(—O/S—C₂₋₂₀)₂₋₂₀alkenyl, aryl-C₂₋₂₀-alkenyl, branched or unbranched heterocyclyl-C₂₋₂₀-alkenyl, C₃₋₂₀-cycloalkenyl, preferably branched and unbranched C₂₋₁₂-alkenyl, branched and unbranched C₁₋₁₂(—O/S—C₂₋₁₂)₂₋₁₂-alkenyl, preferably preferred branched and unbranched C₂₋₆-alkenyl, branched and unbranched C₁₋₆(—O/S—C₂₋₈)₂₋₈-alkenyl; alkinyl represents branched and unbranched C₂₋₂₀-alkinyl, branched and unbranched C₁₋₂₀(—O/S—C₂₋₂₀)₂₋₂₀alkinyl, preferably branched and unbranched C₂₋₁₂-alkinyl, branched and unbranched C₁₋₁₂(—O/S—C₂₋₁₂)₂₋₁₂alkinyl, preferably preferred branched and unbranched C₂₋₆-alkinyl, branched and unbranched C₁₋₆(—O/S—C₂₋₈)₂₋₈-alkinyl; cycloalkyl represents bridged and non-bridged C₃₋₄₀-cycloalkyl, preferably bridged and non-bridged C₃₋₂₆-cycloalkyl, preferably preferred bridged and non-bridged C₃₋₁₅-cycloalkyl; aryl represents substituted and unsubstituted mono- or multi-linked phenyl, pentalenyl, azulenyl, anthracenyl, indacenyl, acenaphtyl, fluorenyl, phenalenyl, phenanthrenyl, preferably substituted and un-substituted mono- or multi-linked phenyl, pentalenyl, azulenyl, anthracenyl, indenyl, indacenyl, acenaphtyl, fluorenyl, preferably preferred substituted and unsubstituted mono- or multi-linked phenyl, pentalenyl, anthracenyl, and their partially hydrogenated derivatives. Heterocycles may be unsaturated and saturated 3-15-membered mono-, bi- and tricyclic rings having 1 to 7 heteroatoms, preferably 3-10-membered mono-, bi- and tricyclic rings having 1 to 5 heteroatoms and preferably preferred: 5-, 6- and 10-membered mono-, bi- and tricyclic rings having 1 to 3 heteroatoms. Additionally, 0 to 30 (preferably 0 to 10, preferably preferred 0 to 5) of the following substituents occur solely or in combination attached to alkyl, alkenyl, alkinyl, cycloalkyl, aryl, heteroatom radicals, heterocycles, to the biomolecule or natural material; fluorine, chlorine, bromine, iodine, hydroxyl, amide, ester, acid, amine, acetal, ketal, thiol, ether, phosphate, sulphate, sulfoxide, peroxide, sulphonic acid, thioether, nitrile, urea, carbamate, whereby the following are preferred: fluorine, chlorine, bromine, hydroxyl, amide, ester, acid, amine, ether, phosphate, sulphate, sulfoxide, thioether, nitrile, urea, carbamate, and especially preferred: chlorine, hydroxyl, amide, ester, acid, ether, nitrile.

In the present context, specific chemo-selective immobilization shall be understood as that each biopolymer sequence, particularly an amino acid sequence of the amino acid sequence group, is bound to the molecular fork by a specific reactive group or by a plurality of reactive groups. Due to the specificity of the bonding, the individual amino acid sequences are immobilized in a defined ratio on the molecular fork under typical reaction conditions.

The term “array of amino acid sequence groups” is herein understood particularly in the sense that each amino acid sequence group is immobilized on a specific position on the surface by a molecular fork. Thereby, preferably each one of these positions can be identified. The positions are thus distinct positions, whereby essentially one group of the amino acid sequence is immobilized on each distinct position. In other words, it exists a map from which the site of each of the immobilized amino acid sequence groups on the surface can be derived.

The single amino acid sequence group can represent a plurality of molecules, which, however, are essentially identical with respect to the composition of their amino acid sequence, i.e. the nature and sequence of the amino acids forming the amino acid sequence. The identity of amino acid sequences is defined essentially by the preparation methods of the amino acid sequences. It is within the scope of the present invention that the amino acid sequences are synthesized in situ on the surface, whereby each possible preparation method can be used, for example sequential addition of the single amino acids, forming the amino acid sequence, as well as using block synthesis techniques whereby groups of amino acids are linked together and the individual blocks are sequentially lined-up and the blocks or arrays are subsequently immobilized or added to amino acid sequences being yet immobilized, respectively.

For a skilled person in the art it is obvious that certain heterogeneities may result in the different amino acid sequences, as described in the afore mentioned sense, due to yields which are not always complete within the individual synthesis or coupling steps. Particularly for synthesis methods requiring many reaction steps as for the synthesis of amino acid sequences (one coupling reaction and one cleavage of the protecting group per amino acid monomer, and at the end of the synthesis in general one reaction for the simultaneous cleavage of all protecting groups of the side chain functions alities).

The expected theoretical yield for the synthesis of an amino acid sequence consisting of 20 amino acid units or 40 amino acid units, respectively, whereby the average yield is assumed to be 95% for the 41 respectively 81 reaction steps required, amounts to 0.95⁴¹=0.122 (12.2%) respectively 0.95⁸¹=0.0157 (1.57%). Even in the case that the average yield is assumed to be 99%, the yield amounts to 66.2% and 44.3%, respectively in the above mentioned examples. Thus a specific or directed chemo-selective immobilization is beneficial. The contact between the compound to be immobilized and the molecular fork on the surface, where the compound is to be immobilized, is achieved in one immobilization event in the same manner, and all compounds are bound to the molecular fork at the surface in a defined and predictable orientation.

It is understood that the array comprises a defined number of different amino acid sequence groups. The same amino acid sequence group can be present on several distinct positions on the surface or on the support material, respectively. On the one hand, an internal standard may be realized thereby, on the other hand, potential side effects can be illustrated and detected.

Every bio-compatible, functionalized material or materials, which can be functionalized, can be used as surface materials or as support materials within the scope of the present invention. These materials are for example in the form of solid support plates (monolithic blocks), membranes, films or laminates. Suitable materials are polyolefines, such as for example polyethylene, polypropylene, halogenated polyolefines (PVDF, PVD, etc.) as well as polytetrafluoroethylene. As inorganic materials, ceramics, silicates, silicon and glass can be used. Although non-metal support plates are preferred, it is also within the scope of the present invention to use metal support materials despite their tendency of showing potential non specific adsorption effects. Examples of such materials are gold or metal oxides, such as for example titanium oxide.

The surface structure can vary. It is generally possible that the surface with the molecular forks attached thereto, on which the directed immobilization of amino acid sequences is achieved, is the support material at the same time. It is however also possible that the surface carrying the molecular forks is different from the support material. Such an embodiment is for example realized when the material forming the (preferably planar) surface is in the form of a film, which is deposited on a further basic support material due to stabilization purposes and due to further reasons.

For the purpose of applying the molecular forks, especially if this is done by a covalent bonds on the support material, the surface of the support plate can be functionalized. Generally several subsequent functionalizations are possible, however one functionalization can be suppressed depending on the selected support material.

A first functionalization can be carried out by providing amino and/or carboxyl groups as reactive groups, whereby this first functionalization is suitable to obtain afterwards a covalent bond on the molecular forks on the surface. Such a functionalization is referred to as first functionalization, which is independent from the chemical nature of the applied reactive groups.

The generation of carboxyl groups can for example be carried out by oxidation using chromium acid starting from polyolefines as the surface forming material. Alternatively, this can for example be accomplished by reaction under high pressure with oxalylchloride and plasma oxidation, radical or light-induced addition of acrylic acid and the like. Halogenated materials like halogenated polyolefines lead to the generation of both amino and carboxyl reactive groups by base-catalyzed elimination processes resulting in double bonds at the surface, whereby subsequently the reactive double bonds may be carboxyl or amino functionalized.

Ceramics, glasses, silica and titaniam can be simply functionalized with a plurality of commercially available substituted silanes, such as for example aminopropyltriethoxysilane. Support plates having hydroxyl groups on the surface can be modified by numerous reactions. Particularly advantageous are reactions with biselectrophiles, such as the direct carboxymethylation using bromoacetic acid; acylation using a corresponding amino acid derivative, such as for example the dimethylaminopyridine-catalyzed carbodiimide coupling using fluorenylmethoxycarbonyl-3-aminopropionic acid or the generation of iso(thio)-cyanates by reactions using corresponding bis-iso(thio)cyanates. A particularly advantageous method is the reaction with carbonyldiimidazole or phosgene or triphosgene or p-nitrophenyl-chloroformate and thiocarbonyldiimidazole, respectively, followed by the reaction with a diamine or singly protected diamines in order to attach an amino functionalization via a stable urethane binding to the surface of the support materials.

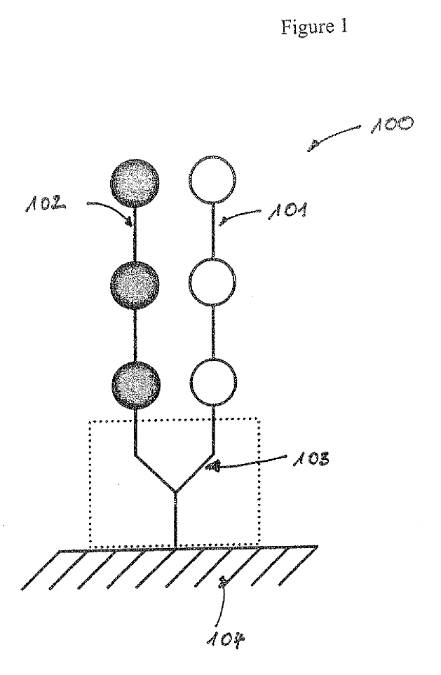

All chemical compounds and structures can be used as molecular forks, if they allow on the one hand the formation of a covalent bond to the surface of the support material and having at least two further chemical functions on the other hand allowing either the stepwise synthesis or the chemo-selective immobilization of biopolymer sequences, whereby further covalent bonds (see FIG. 1) are generated.

Particularly suitable are alkyl, alkenyl, alkinyl, cycloalkyl or aryl radials, or heterocycles, whereby alkyl represents branched and unbranched C₁₋₂₀-alkyl, C₃₋₂₀-cycloalkyl, preferably branched and unbranched C₁₋₁₂-alkyl, C₃₋₁₂-cycloalkyl and particularly preferred branched and unbranched C₁₋₆-alkyl, C₃₋₆-cycloalkyl. Alkenyl represents branched and unbranched C₂₋₂₀-alkenyl, branched and unbranched C₁₋₂₀-alkyl-O—C₂₋₂₀-alkenyl, C₁₋₂₀(—O/S—C₂₋₂₀)₂₋₂₀-alkenyl, aryl-C₂₋₂₀-alkenyl, branched and unbranched heterocyclyl-C₂₋₂₀-alkenyl, C₃₋₂₀-Cycloalkenyl, preferably branched and unbranched C₂₋₁₂-alkenyl, branched and unbranched C₁₋₁₂(—O/S—C₂₋₁₂)₂₋₁₂alkenyl, particularly preferred branched and unbranched C₂₋₆-alkenyl, branched and unbranched C₁₋₆(—O/S—C₂₋₈)₂₋₈alkenyl; alkinyl presents branched and unbranched C₂₋₂₀-alkinyl, branched and unbranched C₁₋₂₀(—O/S—C₂₋₂₀)₂₋₂₀alkinyl; preferably branched and unbranched C₂₋₁₂-alkinyl, branched and unbranched C₁₋₁₂(—O/S—C₂₋₁₂)₂₋₁₂alkinyl, preferably preferred branched and unbranched C₂₋₆-alkinyl, branched and unbranched C₁₋₆(—O/S—C₂₋₈)₂₋₈-alkinyl; cycloalkyl represents bridged and non-bridged C₃₋₄₀-cycloalkyl, preferably bridged and non-bridged C₃₋₂₆-cycloalkyl, preferably preferred bridged and non-bridged C₃₋₁₅-cycloalkyl; aryl represents substituted and un-substituted mono- or multi-linked phenyl, pentalenyl, azulenyl, anthracenyl, indacenyl, acenaphtyl, fluorenyl, phenalenyl, phenanthrenyl, preferably substituted and un-substituted mono- or multi-linked phenyl, pentalenyl, azulenyl, anthracenyl, indenyl, indacenyl, acenaphtyl, fluorenyl, preferably preferred substituted and un-substituted mono- or multi-linked phenyl, pentalenyl, anthracenyl, and their partially hydrogenated derivatives. Heterocycles can be unsaturated and saturated 3-15-membered mono-, bi- and tricyclic rings having 1 to 7 heteroatoms, preferably 3-10-membered mono-, bi- and tricyclic rings having 1 to 5 heteroatoms and preferably preferred: 5-, 6- and 10-membered mono-, bi- and tricyclic rings having 1 to 3 heteroatoms.

Additionally, 0 to 30 (preferably 0 to 10, preferably preferred 0 to 5) of the following substituents like the present alone or in combination with each other at the alkyl, alkenyl, alkinyl, cycloalkyl, aryl, heteroatom radicals and heterocycles, at the biomolecule or at the natural product: fluorine, chlorine, bromine, iodine, hydroxyl, amide, ester, acid, amine, acetal, ketal, thiole, ether, phosphate, sulphate, sulfoxide, peroxide, sulphonic acid, thioether, nitrile, urea, carbamate, whereby the following are preferred: fluorine, chlorine, bromine, hydroxyl, amide, ester, acid, amine, ether, phosphate, sulphate, sulfoxide, thioether, nitrile, urea, carbamate, and especially preferred are: chlorine, hydroxyl, amide, ester, acid, ether, nitrile.

On the one hand the molecular fork comprises a first chemical reactive group for the immobilization on a macromolecular surface. This first reactive group is selected from the group comprising alcohols, amines, carboxylic acids, carbonyl compounds, hydroxyl amines, aldehydes, ketones, acetals, ketals, amino-oxy compounds, azides, hydrazides, thiols, thiocarbonyl compounds, thioketals and thioacetals, sulfides, sulfonates, alkenes, alkines, halogenated compounds and cyano compounds, such that in preferred embodiments the link to the functionalized surface is formed by —CONH—, —O—, —S—, —COO—, —CH═N—, —NHCONH—, —NHCSNH, —C—C— or —NHNH— groups.

On the other hand, the molecular fork comprises at least a second or a third chemical reactive group for the immobilization or stepwise synthesis of biopolymer sequences. This group comprises but is not limited to alcohols, amines, carboxylic acids, carbonyl compounds, hydroxyl amines, aldehydes, ketones, acetals, ketals, amino-oxy compounds, azides, hydrazides, thiols, thiocarbonyl compounds, thioketals and thioacetals, sulfides, sulfonates, alkenes, alkines, halogenated compounds and cyano compounds. They may be mastered by protecting groups.

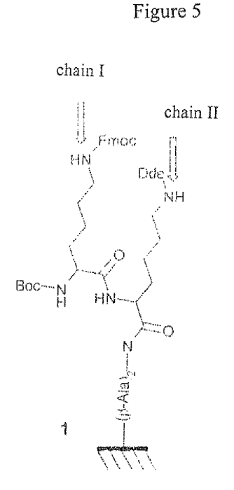

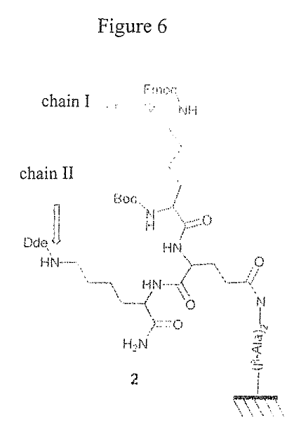

The chemical functionalities for the synthesis or the chemoselective immobilization of biomolecules do not necessarily have to be of a different chemical nature (see FIGS. 5 and 6). It is sufficient that these chemical functionalities are protected, such that these chemical functionalization can be classified and removed in an arbitrary sequence using methods known by a skilled person in the art.

In a preferred embodiment of the invention, the molecular forks allow that the number of biopolymer sequence molecules, which are covalently attached on one side of a molecular fork, is very similar or identical to the number of biopolymer sequence molecules, which are covalently attached on this side of the molecular fork.

According to the present invention the amino acid sequences immobilized on the molecular fork are provided with a spacer. Due to the use of such a spacer, the amino acid sequences gain additional degrees of freedom, in order to effectively interact with one another within the amino acid sequence group. The spacer can be every molecule, especially every bio-compatible molecule, which comprises at least two functional groups or groups which may be functionalized. When present, the spacer is incorporated as an element between the molecular fork attached to the surface and the amino acid sequence.

The following classes of compounds can be used as a spacer:

Alkanes, branched or unbranched, particularly those having a chain length of C₂ to C₃₀, especially C₄ to C₈; polyether, i.e. polymers of polyethylene oxides or polypropylene oxides, whereby the polyether consists preferably of 1 to 5 polyethylene oxide units or polypropylene oxide units respectively; branched or unbranched polyalcohols, such as polyglycol and their derivatives, such as for example O,O′-bis(2-aminopropyl)-polyethylene glycol 500 and 2,2′-(ethylene dioxide)-diethyl amine; polyurethanes, polyhydroxy acids, polycarbonates, polyimides, polyamides, polyesters, polysulfones, especially those consisting of 1 to 100 monomer units, particularly preferred are those within 1 to 10 monomer units; combinations of the foregoing alkanes with the foregoing mentioned polyethers; polyurethanes, polyhydroxy acids, polycarbonates, polyimides, polyamides, polyamino acids, polyesters and polysulfones; diaminoalkanes, branched or unbranched, especially those having a chain length of C₂ to C₃₀, preferably preferred those having a chain length of C₂ to C₈; typically 1,3-diaminopropane, 1,6-diaminohexane, and 1,8-diaminooctane, and their combinations with polyethers, especially with the foregoing mentioned polyethers such as for example 1,4-bis-(3-aminopropoxy-butane; dicarboxylic acids and their derivatives, such as for example hydroxyl, mercapto and amino-dicarboxylic acids, saturated and unsaturated, branched or unbranched, especially C₂ to C₃₀ dicarboxylic acids, especially those having a chain length of C₂ to C₁₀, especially preferred those having a chain length of C₂ to C₆; such as for example succinic acid and glutaric acid; and amino acids and peptides, especially those having lengths of 1 to 20 amino acid groups, particularly preferred having a length of 1 to 3 amino acid groups, typically trimers of lysine, dimers of 3-aminopropionic acid and the monomeric 6-aminocaproic acid.

Due to the fact that the spacer has two functional ends, it is in general possible to select these functionalities such that the amino acid sequences to be immobilized on the surface are immobilized either by their C-terminus or their N-terminus or by another functional group in the amino acid sequence to be immobilized. In the case an immobilization is obtained by the C-terminus, the C-terminus attacking functional group of the spacer is preferably an amino group. In the case the amino acid sequences are to be immobilized by the N-terminus to the surface, a carboxylic group is the corresponding functional group of the spacer.

According to an array of the invention, the spacer is a branched spacer. Such branched spacers are termed as dendritic structures or dendrimers, which are known by a person skilled in the art. Dendrimers useful for the immobilization of nucleic acids are for example described in Beier, M. & Hoheisel, J. D., 1999, Versatile derivatisation of solid support media for covalent bonding on DNA-microchips, 9, 1970-1977. The function of these dendrimers is that the amount of reactive groups per unit area of the surface and thus the signal intensity is increased. Dendrimers can have almost all functional groups or groups which can be functionalized, if these groups allow the immobilization of amino acid sequences. Due to the use of such dendrimers, the amount of reactive groups per unit area of the planar surface may be increased by a factor of from 2 to 100, preferably by a factor of from 2 to 20 and especially preferred by a factor of from 2 to 10.

After attaching a spacer to the molecular fork, a further functionalization may be carried out. In other words, the remaining reactive group of the spacer is further functionalized by additional measures. This second functionalization can be carried out directly at the molecular fork, at the molecular fork having a spacer or at the dendrimer.

One reason for the second functionalization is that due to the amino and carboxylic groups, thiol functions, imidazol functions and guanido function available in the amino acid sequence, a unified immobilization with respect of the orientation of the amino acid sequence may not always be obtained. A second functionalization offers the route to further chemo-selective reactions in order to obtain a directed immobilization.

All those compounds having non-proteinogenic functionalized groups are suitable for the second functionalization. As an example the following compounds should be mentioned without being understood as a limitation: maleinimido compounds such as maleinimido amines or maleinimido carboxylic acids; halogenated alpha-ketones such as bromopyruvic acid or 4-carboxy-alpha-bromoacetophenone, alpha-isothiocynato ketones such as 4-carboxy-alpha-isothiocyanato acetophenones, aldehydes such as carboxybenzaldehyde, ketones such as levulinic acid, thiosemicarbazides, thioamides such as succinic acid monothioamide, alpha-bromocarboxylic acid such as bromoacetic acid, hydrazines, such as 4-hydrazinobenzoe acid, O-alkylhydroxyl amines such as amino-oxy-acidic acid, and hydrazides such as glutaric acid monohydrazide.

With regard to an embodiment of the device according to the invention, those sites or domains of the surface are blocked, which do not have an amino acid sequence group. By this blocking, groups are inactivated, which have not been reacted with the functionalized molecular forks and which are still reactive at the molecular fork or at the surface, during or after the chemo-selective reaction of the amino acid sequences. This blocking reaction is necessary since otherwise the added proteins or other components of the used biological samples react unspecifically with these reactive groups which are not blocked yet, and thereby would cause a large background signal. Such unspecific reactions with surfaces are frequently reasons for detrimental signal to noise ratios in biochemical analysis. Compounds suitable for this blocking are those, which have a larger sterical hindrance, which are reactive with the groups to be blocked and which generate favourable surface properties. The selection of these compounds depend on the kind of the sample or the interaction partners interacting with one of the amino acid sequence groups.

The compound is preferably hydrophilic, when the proteins used bind preferably on hydrophobic surfaces, and the compound is preferably hydrophobic, when the samples used bind unspecifically preferably to hydrophilic surfaces. It is known by a person skilled in the art, that a biomolecule such as for example a protein needs a three-dimensional, exactly defined structure for its proper biological function. This tertiary structure tremendously depends on the environment. As such, a protein tends to keep all, or better as much as possible, hydrophobic groups in its inner part when present in water, in which is a hydrophilic solvent. If such a protein reaches a more hydrophobic environment (hydrophobic surface), the protein may change its folding, which may result in an inactivation. On the other hand, there are proteins occurring in (hydrophobic) biomembranes as their natural environment. Such proteins would refold while contacting a hydrophilic surface and would thereby denaturize or would be inactivated. In such a case, a hydrophobic surface is desirable.

The components of amino acid sequences of the device according to the invention are amino acids and are preferably selected from a group comprising L- and D-amino acids. Furthermore, the amino acids are selected from the group comprising natural and non-natural amino acids. A preferred group in all of the afore mentioned groups of amino acids are the corresponding alpha-amino acids. The amino acid sequences consist for example of a sequence of amino acids from each of the above mentioned groups. A combination of D- and L-amino acids is for example within the scope of the invention as well as amino acid sequences exclusively consisting either of D- or L-amino acids. The components of amino acid sequences may moreover comprise other molecules as amino acids. Examples are thioxo amino acids, hydroxyl acids, mercapto acids, dicarboxylic acids, diamines, dithioxocarboxylic acids, acids and amines. A further form of derivatives of amino acid sequences are the so-called PNAs (peptide nucleic acids).

The density of the amino acid sequence groups is from 1/cm² to 1.000/cm², whereby the preferred density is from 1/cm² to 500/cm² and particularly preferred from 1/cm² to 200/cm². Such densities of distinct sites on a surface, each comprising one amino acid sequence group, can be obtained using different techniques, such as for example a piezoelectric driven pipette automats having fine needles made from different materials such as polypropylene, stainless steel or tungsten and corresponding alloys respectively, having so-called pin-tools, being either slotted needles or made by a ring containing the compound mixture, which is to be applied, and a needle which deposits the compound mixture contained in this ring onto the corresponding surface. Capillaries connected with an engine driven syringe are suitable (spotter). A further possibility is the deposition of the amino acid sequences which are to be immobilized by suitable small pistons.

The deposition of amino acid sequences to be immobilized by use of suitable pipettes or so-called multi-pipettes by hand is possible as well. Further, the above mentioned densities of distinct sites can be generated by the direct in situ synthesis of amino acid sequences on the molecular forks of the surface (M. Stankova et al., 1994, Pept. Res., 7, 292-298, F. Rasoul et al.; 2000; Biopolymers, 55, 207-216, H. Wenschuh et al., 2000, Biopolymer., 55, 188-206, R. Frank, 1992, Tetrahedron, 48, 9217-9232; A. Kramer and J. Schneider-Mergener, Methods in Molecular Biology, Vol. 87: Combinatorial Peptide Library Protocols, p. 25-39, edited by; S. Cabilly; Humana Press Inc., Totowa, N.J.; Töpert, F. et al., J., 2001, Angew. Chem. Int. Ed., 40, 897-900, S. P. A. Fodor et al.; 1991, Science, 251, J. P. Pellois, W. Wang, X. L. Gao ; 2000, J. Comb. Chem., 2, 355-360).

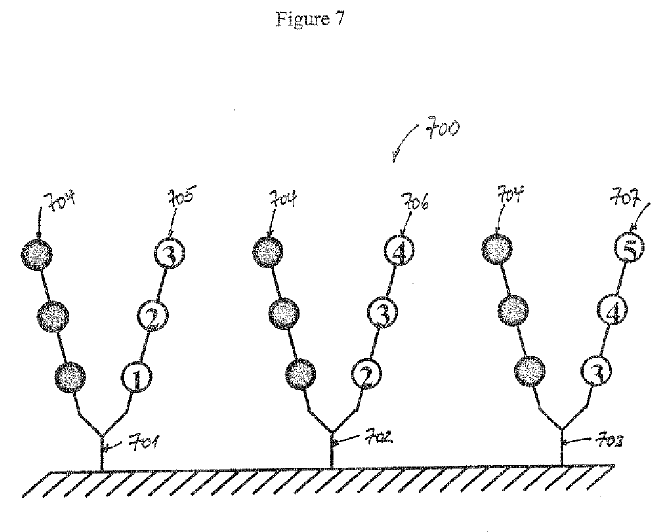

In a preferred embodiment of the device according to the invention and their different uses and applications, different amino acid sequence groups consist of two different sequences and one of these sequences is identical in all of the different amino acid sequence groups (FIG. 7). Or there are two sequences chemically different from one another such as for example a nucleic acid sequence and a amino acid sequence etc. The sum of all two (non-identical) sequences represents overlapping peptides in case of amino acid sequences, which cover the entire primary structure of the protein.

The detection indicating that a binding event has been occurred within one or several of the different amino acid sequence groups can be made by using different techniques known by a person skilled in the art. The interaction between different amino acid sequence derivatives can be detected by the change of the fluorescence signal. Principally all reactions and physical phenomena being sensitive with respect to a change in distance may be used for the detection of interactions between amino acid sequences within an amino acid sequence group. An example for such reactions and physical phenomena are fluorescence energy resonance transfer (FRET), Dexter-transfer, electron-spin resonance, nuclear-magnetic resonance (NMR), especially ¹⁹F-NMR and light flash induced free radical reactions.

Alternatively, the detection indicating that a binding event took place within one or several of the different amino acid sequence groups, and the detection of amino acid sequence auxiliary structures is carried out, such that only in the case of an interaction between the amino acid sequence of an amino acid sequence group a new structure is formed from the auxiliary structures, which are brought into contact by the interaction of amino acid sequences, which again is selectively detected.

Such a structure may be a structure called a discontinuous epitope, which is known to someone skilled in the art, and can be detected selectively via the bonding of suitable antibodies. On the other hand, these auxiliary structures can be elements, which tend to dimerization or oligomerization under certain circumstances if there is an interaction between the amino acid sequences of an amino acid sequence group. Examples for such auxiliary structures are complementary DNA or RNA, or PNA strands. Further examples for such auxiliary structures are short oligoproline sequences, whereby a person skilled in the art knows that these sequences form a so-called polyproline or tripel-helix, respectively, after a certain pre-orientation, whereby the helix generates again a specific CD-signal.

Moreover, the present invention provides a method for searching substances which inhibit the interaction of immobilized biopolymers. Here the change of a signal, which results from one of the above described detection methods, is read out after contacting the array with an agent which is selected from the group of pharmaceutical agents, or potential pharmaceutical agents, organic molecules or natural materials.

Further advantages and embodiments of the present invention are illustrated by the enclosed Figures. It is understood that the present invention is not limited by the disclosed features, but applies also to arbitrary combinations of the above explained and below to be explained features and the features to be explained below.

FIG. 1 shows the schematic design of a molecular fork, which on the one hand is immobilized on the surface of a support and which on the other hand carries two different biopolymer sequences,

FIG. 2 shows schematically shows possible interactions of two different biopolymers immobilized on the surface by a binary molecular fork;

FIG. 3 shows an overview of different chemo-selective reactions,

FIG. 4 schematically shows the procedure with regard to the loading of binary molecular forks with two different amino acid sequences by subsequent chemo-selective immobilization reactions.

FIG. 5 shows the chemical structure of the exemplary molecular fork MG1,

FIG. 6 shows the chemical structure of the exemplary molecular fork MG2,

FIG. 7 shows the illustration of a specific embodiment of the invention,

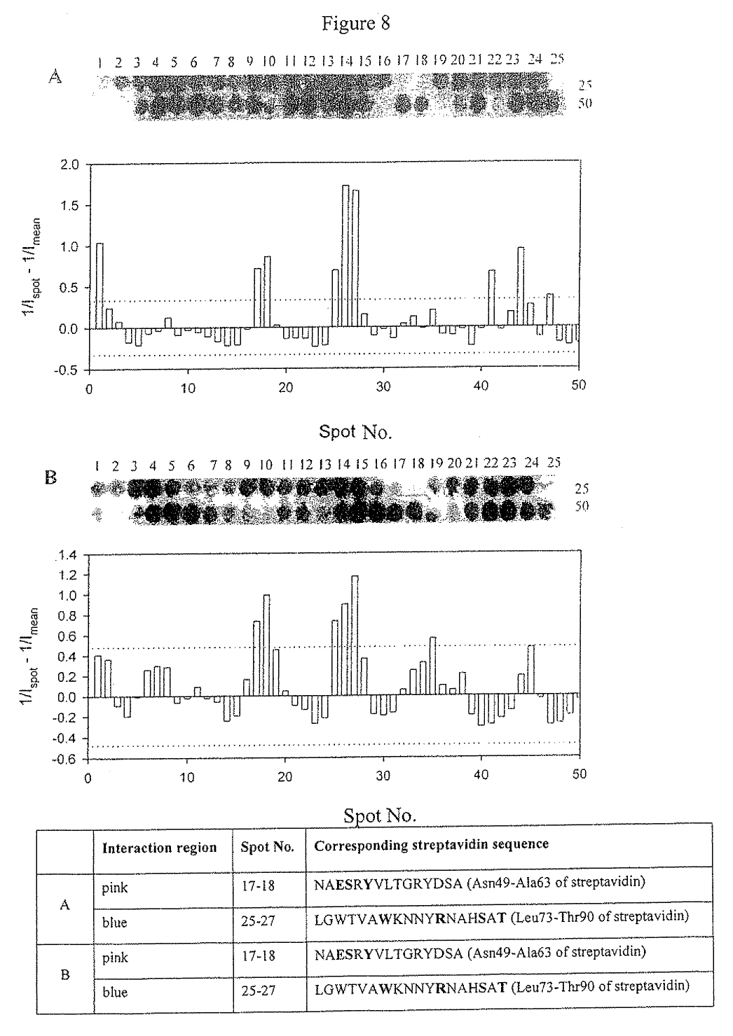

FIG. 8 shows the analysis of the streptavidine/strep-tag II interaction using the exemplary molecular fork MG1.

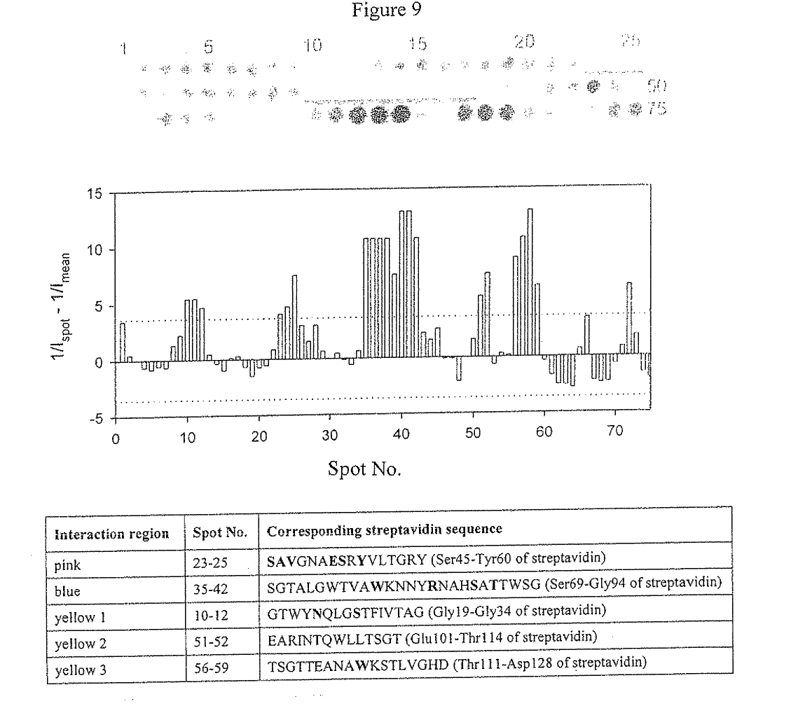

FIG. 9 shows the analysis of the streptavidine/strep-tag II interaction using the exemplary molecular fork MG2.

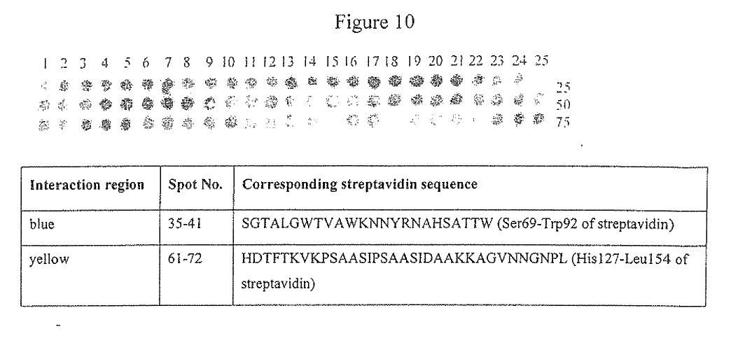

FIG. 10 shows the analysis of the streptavidine/strep-tag II interaction using the molecular fork MG2 attached to a amino functionalized APEG-amino-polypropylene surfaces,

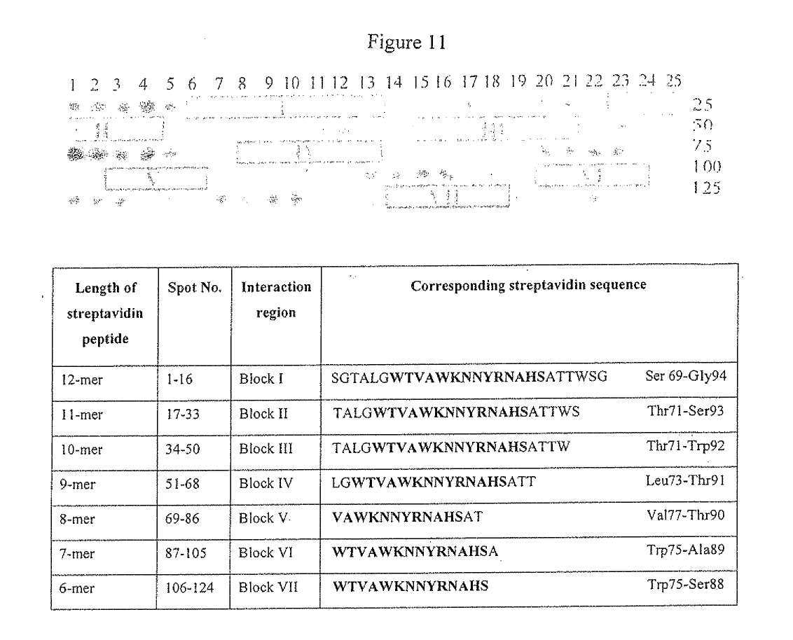

FIG. 11 shows the map of the length of the streptavidine/strep-tag II interaction areas using the molecular fork MG2 and the particular embodiment of the invention shown in FIG. 7,

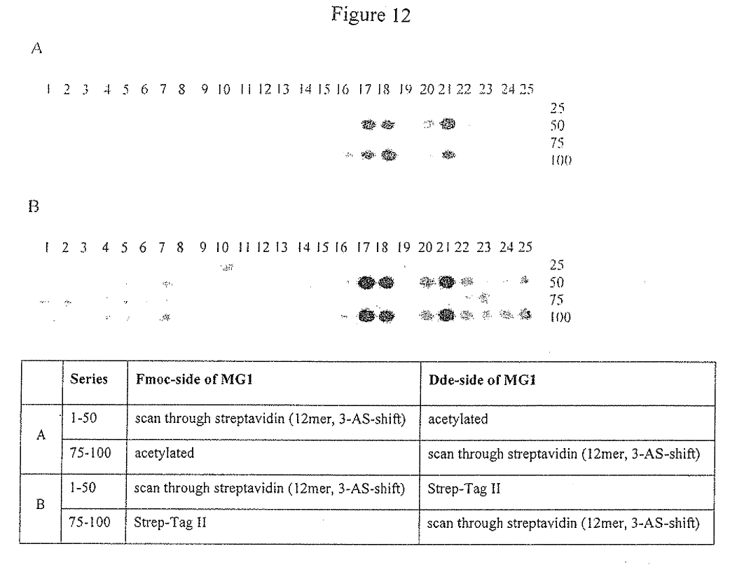

FIG. 12 shows the analysis of the streptavidine/strep-tag II interaction using the inhibition with the natural material biotine.

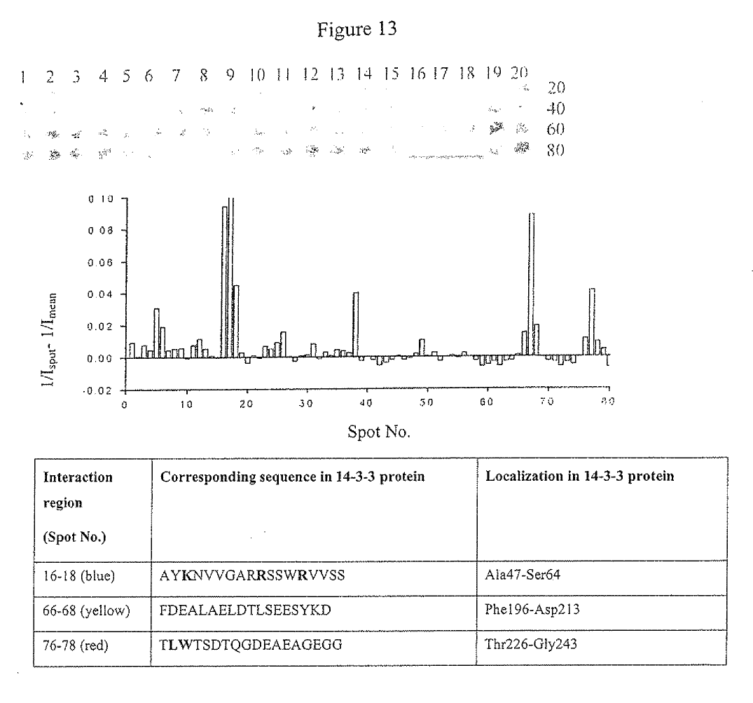

FIG. 13 shows the map of interaction sites of Raf-peptides (RQRSTpSTPNV) on the 14-3-3 protein.

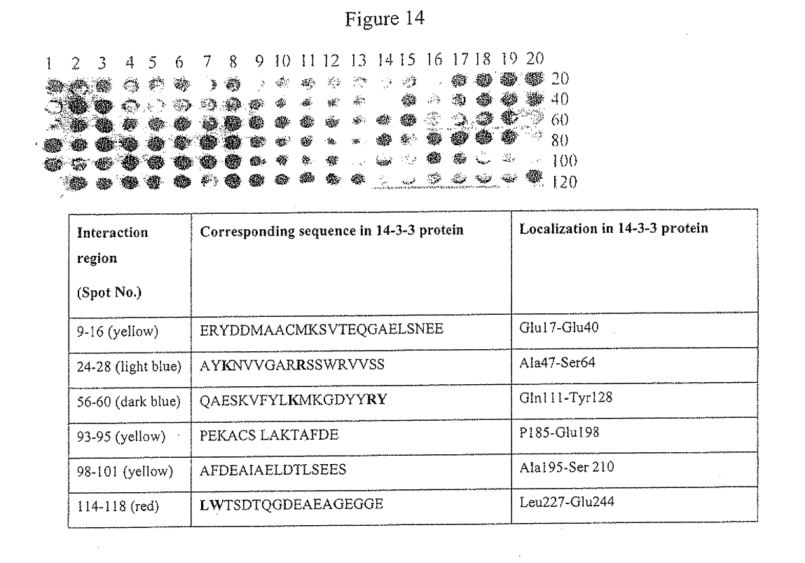

FIG. 14 shows the map of interaction site of the mT-peptide (ARSHpSYPA) on the 14-3-3 protein.

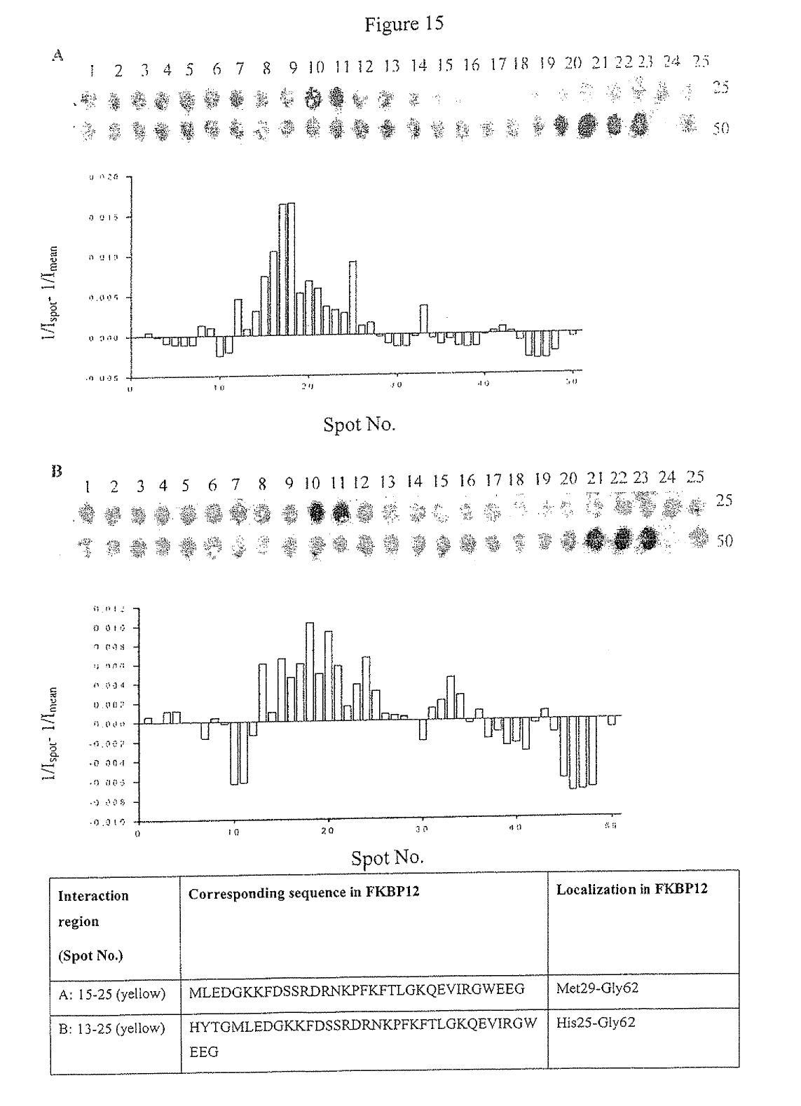

FIG. 15 shows the map of interaction site of the FKBP12/FAP48 interaction.

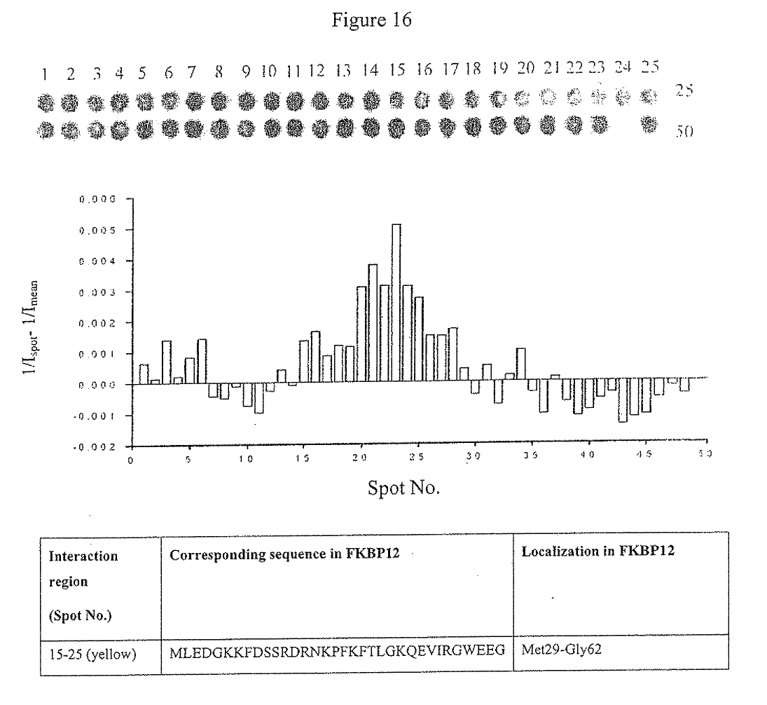

FIG. 16 shows the map of the interaction site of the FKBP12/EGF-receptor interaction.

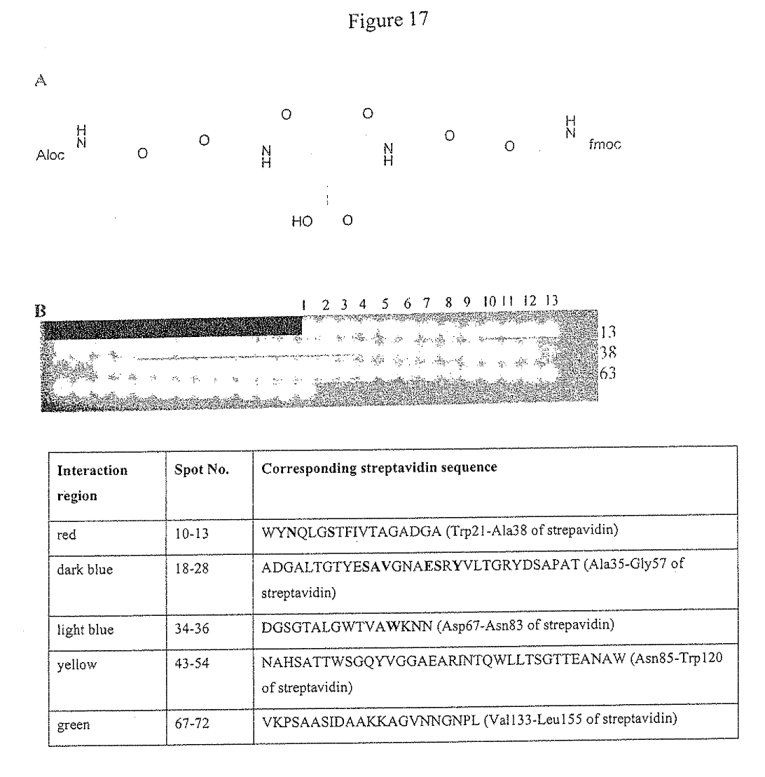

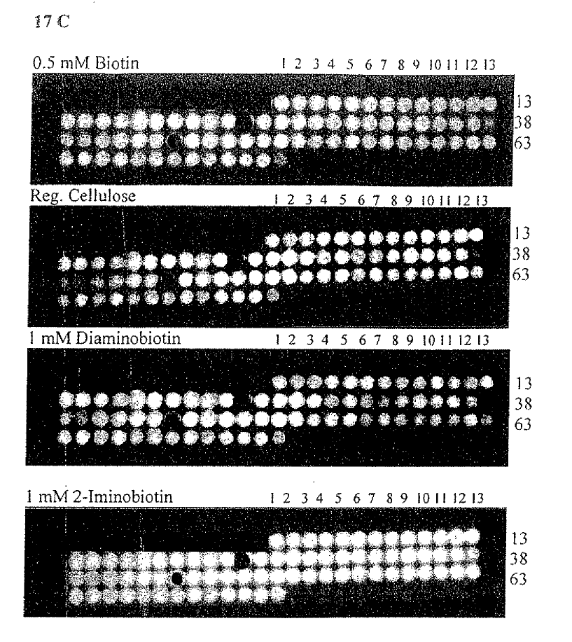

FIG. 17 shows the inhibition of streptavidine-peptide/strep-tag II interaction using the natural product biotine and its derivatives.

In FIG. 1 the schematic design of the device 100 according to the invention is shown where the two different biopolymer sequences 101 and 102 are immobilized by a binary molecular Y 103 on a suitable support surface 104.

FIG. 2 shows the schematic design of an array 200 according to the invention, whereby in FIG. 2A two non-interacting biopolymer sequences 201 and 202 are immobilized by a binary molecular fork 203 on a suitable support surface 204. FIG. 2B shows schematically the possible interaction of identical biopolymer sequences 208, 209, which are immobilized on different, adjacent molecular forks 205, 206. In FIG. 2C2, the interaction of different biopolymer sequences 213, 214, 215, 216 is shown, which are immobilized on different adjacent molecular forks 218, 219. Moreover, FIG. 2C1 shows the interaction of two different biopolymer sequences 211, 212 immobilized on a molecular fork. It is obvious for a skilled person in the art that the proportion of cases B and C2 depend to a large extent on the density of the loaded molecular forks on the support surface.

FIG. 3 shows an overview of different chemo-selective reactions according to the state of the art: A) aldehyde (R⁴═H) or ketones (R⁴ not H) and amino-oxy compounds react to oximes, B) aldehydes (R⁴═H) or ketones (R⁴ not H) and thiosemicarbazides react to thiosemicarbazones, C) aldehydes (R⁴═H) or ketones (R⁴ not H) and hydrazides react to hydrazones, D) aldehydes (R⁴═H) or ketones (R⁴ not H) and 1,2-aminothiols react to thiazolines (X═S) or 1,2-aminoalcohols to oxazolines (X═O), or 1,2-diamines react to imidazolines (X═NH), E) thiocarboxylates and halogenated alpha-carbonyles react to thioesters, F) thioesters and β-aminothiols react to β-mercaptoamides, G) mercaptanes and maleinimides react to succinimides.

The radical R¹ represents alkyl, alkenyl, alkinyl, cycloalkyl or aryl or heterocycles, respectively, or surfaces and the radicals R⁴-R⁶ represent alkyl, alkenyl, alkinyl, cycloalkyl or aryl, respectively heterocycles or surfaces or H, D, T, respectively, whereby alkyl represents branched or unbranched C₁₋₂₀-alkyl, C₃₋₂₀-cycloalkyl, preferably branched or unbranched C₁₋₁₂-alkyl, C₃₋₁₂-cycloalkyl and especially preferred branched or unbranched C₁₋₆-alkyl, C₃₋₆-cycloalkyl. Alkenyl represents branched and unbranched C₂₋₂₀-alkenyl, branched and unbranched C₁₋₂₀-alkyl-O—C₂₋₂₀-alkenyl, C₁₋₂₀(—O/S—C₂₋₂₀)₂₋₂₀alkenyl, aryl-C₂₋₂₀-alkenyl, branched and unbranched heterocyclyl-C₂₋₂₀-alkenyl, C₃₋₂₀-cycloalkenyl, preferably branched and unbranched C₂₋₁₂-alkenyl, branched and unbranched C₁₋₁₂(—O/S—C₂₋₁₂)₂₋₁₂alkenyl, especially preferred branched and unbranched C₂₋₆-alkenyl, branched and unbranched C₁₋₆(—O/S—C₂₋₈)₂₋₈alkenyl; alkinyl represents branched and unbranched C₂₋₂₀-alkinyl, branched and unbranched C₁₋₂₀(—O/S—C₂₋₂₀)₂₋₂₀alkinyl, preferably branched and unbranched C₂₋₁₂-alkinyl, branched and unbranched C₁₋₁₂ (—C/S—C₂₋₁₂)₂₋₁₂alkinyl, especially preferred branched and unbranched C₂₋₆-alkinyl, branched and unbranched C₁₋₆—(—O/S—C₂₋₈)₂₋₈-alkinyl; cycloalkyl represents bridged and non-bridged C₃₋₄₀-cycloalkyl, especially preferred bridged and non-bridged C₃₋₂₆-cycloalkyl, especially preferred bridged and non-bridged C₃₋₁₅-cycloalkyl, aryl represents substituted and non-substituted mono- or multi-linked phenyl, pentalenyl, azulenyl, anthracenyl, indacenyl, acenaphtyl, fluorenyl, phenalenyl, phenathrenyl, especially preferred substituted and non-substituted mono- or multi-linked phenyl, pentalenyl, azulenyl, anthracenyl, indenyl, indacenyl, acenaphtyl, fluorenyl, especially preferred for substituted and non-substituted mono- or multi-linked phenyl, pentalenyl, anthracenyl, and their partly hydrogenated derivatives. Heterocycles may be unsaturated and saturated 3-15-membered mono-, bi- and tricyclic rings having 1 to 7 heteroatoms, preferably 3-10-membered mono-, bi- and tricyclic rings having 1 to 5 heteroatoms and especially preferred: 5, 6 and 10-membered mono-, bi- and tricyclic rings having 1 to 3 heteroatoms.

Additionally, 0 to 30 (preferably 0 to 10, especially preferred 0 to 5) of the following substituents may occur alone or in combination with each other at the alkyl, alkenyl, alkinyl, cycloalkyl, aryl, heteroatom radicals, heterocycles, at the biomolecule or the natural material: fluorine, chlorine, bromine, iodine, hydroxyl, amide, ester, acid, amine, acetal, ketal, thiol, ether, phosphate, sulphate, sulfoxide, peroxide, sulphonic acid, thioether, nitrile, urea, carbamate, whereby the following are preferred: fluorine, chlorine, bromine, hydroxyl, amide, ester, acid, amine, ether, phosphate, sulphate, sulfoxide, thioether, nitrile, urea, carbamate, and especially preferred: chlorine, hydroxyl, amide, ester, acid, ether, nitrile.

FIG. 4 shows the schematic design of a device according to the invention 400, where two different biopolymer sequences 403, 404 are immobilized by a binary molecular fork 401 on a suitable support surface 405, known by a person skilled in the art and which is obtained by chemo-selective reactions illustrated in FIG. 3. Thereby, the first biopolymer sequence 403 is firstly anchored on the molecular fork via a chemo-selective immobilization reaction under formation of a chemical bond (reaction step A). In a subsequent reaction B, the second biopolymer sequence 404 is also anchored on the molecular fork 401, by the formation of a chemical bond 407 by a chemo-selective immobilization reaction which is preferably different from the first immobilization reaction. The so formed, completely loaded binary molecular fork 401 represents one embodiment according to the invention.

FIG. 5 shows the structure of the molecular fork MG1 bound to the surface of the support by two β-alanine spacer molecules. Fmoc and Dde represent protecting groups known by a skilled person in the art allowing the load of the molecular fork with corresponding biomolecules after their selective removal.

FIG. 6 shows the structure of the molecular fork MG2 bound to the surface of the support by two S-alanine spacer molecules. Fmoc and Dde represent protecting groups known by a skilled person in the art allowing the load of the molecular fork with corresponding biomolecules after their selective removal.

FIG. 7 shows a particular embodiment 700 according to the invention using binary molecular forks. The identical biopolymer sequence 704 is either immobilized on one side of the molecular fork 701, 702, 703 or stepwise synthesized (black spheres correspond to biomonomers; each left biopolymer sequence is identical in this example). On the second side of the molecular fork partial biopolymer sequences 705, 706, 707, e.g. peptides are either immobilized or stepwise synthesized representing the sequence of a naturally occurring biopolymer, e.g. a protein, as overlapping biopolymer parts. The entire sequence or as well only one or several domains of the sequence can be represented by the entirety of the sequence domains. In the example shown, the desired biopolymer sequence 705, 706, 707 is illustrated by overlapping trimer sequence domains having two overlapping biomonomers. Obviously there are different degrees of overlapping possible as well as a zero overlapping, which means no overlapping, whereby the degree of overlapping is again dependent on the total length of the sequence domain. In case proteins are illustrated as biopolymer sequences using overlapping sequence domains, the total sequence domains are known to a person skilled in the art as peptide scan. It is a special feature shown in present FIG. 7 that on the one hand all binary molecular forks 701, 702, 703 are identical in a molecule, but they form a biopolymer scan with the second half 705, 706, 707.

FIG. 8 shows the interactions of 50 peptide pairs corresponding to the embodiment having overlapping dodecapeptides shown in FIG. 7, which represent the streptavidine sequence and the strep-tag II peptide. The cellulose modified by molecular forks MG1 with peptide pairs was analyzed using 100 nM streptavidine followed by Western Blot-analysis and immunodetection.

A) The constant peptide block strep-tag II was synthesized at the Dde-side. At the Fmoc-side, overlapping 12 mer peptides having an overlap of 9 amino acids were synthesized, which span the entire streptavidine sequence. The densitometric analysis was carried out using a GS-700 imaging densitometer (Bio-Rad). The ordinate represents the difference from the inverse value of the intensity of an analyzed spot and the inverse value of the average spot intensities. Large positive values correspond to a weak signal in the blot and show potential interactions within the peptide pair.

B) The constant peptide block strep-tag II was synthesized at the Fmoc-side. At the Dde-side, the overlapping 12 mer peptides were synthesized having the overlap of 9 amino acids spanning the entire streptavidine-sequence. The densitometric analysis was carried out using a GS-700 imaging densitometer (Bio-Rad). The ordinate represents the difference of the inverse value of the density of each analyzed spots and the inverse value of the average spot intensities. Large positive values correspond to a weak signal in the blot and show potential interactions within the peptide pair. The streptavidine sequences corresponding to the interacting peptides are shown in the table.

FIG. 9 shows the interactions in 75 peptide pairs corresponding to the embodiment shown in FIG. 7 having overlapping dodecapeptides representing the streptavidine-sequence and the strep-tag II-peptide. The cellulose modified by molecular forks MG2 with peptide pairs was analyzed using 100 nM streptavidine followed by Western Blot-analysis and immunodetection.

The constant peptide block strep-tag II was synthesized at the Dde-side. At the Fmoc-side, overlapping 12 mer peptides were synthesized spanning the entire streptavidine-sequence with a 2-amino acid shift. The densitometric analysis was carried out using a GS-700 imaging densitometer (Bio-Rad). The ordinate represents the difference of the inverse value of the density of each analyzed spots and the inverse value of the average spot intensities. Large positive values correspond to a weak signal in the blot and show potential interactions within the peptide pair. The streptavidine sequences corresponding to the interacting peptides are shown in the table.

FIG. 10 shows the interactions of 75 peptide pairs corresponding to the embodiment shown in FIG. 7 having overlapping dodecapeptides representing the streptavidine-sequence and the trep-tag II-peptide. The APEG-amino-polypropylen surface modified by molecular forks MG2 with peptide pairs was analyzed using 100 nM streptavidine followed by Western Blot-analysis and immunodetection.

The constant peptide block strep-tag II was synthesized at the Dde-side. At the Fmoc-side, overlapping 12 mer peptides were synthesized spanning the entire streptavidine-sequence with a 2-amino acid shift. The densitometric analysis was carried out using a GS-700 imaging densitometer (Bio-Rad). The ordinate represents the difference of the inverse value of the density of each analyzed spots and the inverse value of the average spot intensities. Large positive values correspond to a weak signal in the blot and show potential interactions within the peptide pair. The streptavidine sequences corresponding to the interacting peptides are shown in the table.

FIG. 11 shows the interactions in peptide pairs corresponding to the embodiment shown in FIG. 7 with overlapping peptides having varying lengths, whereby the peptides represent the streptavidine-sequence Arg59-Ala100 and strep-tag II-peptide. The constant peptide block strep-tag II was synthesized at the Dde-side. At the Fmoc-side, overlapping 12 mer to 6 mer peptides were synthesized spanning the streptavidine-sequence Arg59-Ala100 with a 2-amino acid shift. The cellulose modified by molecular forks MG2 with peptide pairs was analyzed using 50 nM streptavidine followed by Western Blot-analysis and immunodetection.

The streptavidine-sequences, which correspond to the interacting peptides and which thus represent the minimum binding motif, are shown in the table.

FIG. 12 shows the bond blocked by biotine of the streptavidine on the strep-tag II-peptide. The cellulose, which was modified with peptide pairs corresponding to the embodiment shown in FIG. 7 by molecular forks MG1, was analyzed using the previously formed biotine/streptavidine-complex (60 μg streptavidine/6 μg biotine, 1 h pre-incubation) followed by Western Blot-analysis and immunodetection. A) Only just one side on the MG1 was attached to oligopeptides of the streptavidine-scans. The other side was modified by an acetylation reaction. B) Only just one side on the MG1 was attached to oligopeptides of the streptavidine-scan, and the strep-tag II-peptide was synthesized on the other side. The thus obtained embodiment corresponds to the embodiment of the invention shown in FIG. 7.

FIG. 13 shows the interactions within 80 peptide pairs corresponding to the embodiment shown in FIG. 7 with overlapping dodecapeptides representing the sequence of 14-3-3-proteins and the Raf-peptide RQRSTpSTPNV (pS=phosphoserine). The cellulose modified with peptide pairs by molecular forks MG2 was analyzed using 150 nM 14-3-3 protein followed by Western Blot-analysis and immunodetection.

The constant peptide block Raf-peptide was synthesized at the Dde-side. At the Fmoc-Side, overlapping 12 mer peptides were synthesized spanning the entire 14-3-3 protein sequence with a 2-amino acid shift. The densitometric analysis was performed using a GS-700 imaging densitometer (Bio-Rad). The ordinate represent the difference between the inverse value of the intensity of each analyzed spot and the inverse value of the average spot intensities. Large positive values correspond to a weak signal in the blot and show potential interaction in the peptide pair. The 14-3-3 protein-sequences corresponding to the interacting peptides are shown in the table.

FIG. 14 shows the detection of interactions in 120 peptide pairs corresponding to the embodiment shown in FIG. 7 having overlapping decapeptides representing the sequence of the 14-3-3 protein and the ARSHpSYPA (mT peptides; pS=phosphoSerine). The cellulose modified by molecular forks MG2 with peptide pairs was analyzed using 200 nM 14-3-3 protein followed by the Western Blot-analysis and immunodetection.

The constant peptide block mT peptides was synthesized at the Dde-side. At the Fmoc-side, overlapping 10 mer peptides were synthesized spanning the entire 14-3-3 sequence with a 2-amino acid shift. The densitometric analysis was performed using a GS-700 imaging densitometer (Bio-Rad). The ordinate represent the difference between the inverse value of the intensity of each analyzed spot and the inverse value of the average spot intensities. Large positive values correspond to a weak signal in the blot and show potential interactions within the peptide pair. The 4-3-3 protein sequences corresponding to the interfering peptides are shown in the table.

FIG. 15 shows the detection of interactions within 48 peptide pairs corresponding the embodiment shown in FIG. 7 with overlapping dodecapeptides representing the FKBP12-sequence and peptides derived from FAP48, which interact with FKBP12.

A) The cellulose modified with peptide pairs by molecular forks MG2 was analyzed using 200 nM FKBP12 followed by Western Blot-analysis and immunodetection. The constant peptide block acetyl-KCPLLTAQFFEQS of FAP (Lys217-Ser229) was synthesized at the Dde-side. At the Fmoc-side, overlapping 13 mer peptides were synthesized spanning the entire FKBP12-sequence with a 2-amino acid shift. The densitometric analysis was performed using a GS-700 imaging densitometer (Bio-Rad). The ordinate represents the difference from the inverse value of the intensity of each spot and the inverse value of the average spot intensities. Large positive values correspond to a weak signal in the blot and show potential interactions within the peptide pair.

B) The cellulose modified with peptide pairs by molecular forks MG2 was analyzed using 200 nM FKBP12 followed by the Western Blot-analysis and immunodetection. The constant peptide block Ac-LSPLYLLQFNMGH of FAP (Leu307-His319) was synthesized at the Dde-side. At the Fmoc-side, overlapping 13 mer peptides were synthesized spanning the entire FKBP12-sequence with a 2-amino acid shift. The densiometric analysis was performed using a GS-700 imaging densitometer (Bio-Rad). The ordinate represents the difference from the inverse value of the intensity of each analyzed spot and the inverse value of the average spot intensities. Large positive values correspond to a weak signal in the blot and show potential interactions within the peptide pair.

In both experiments, the region Met21-Glu69 was detected as the interaction region in FKPB12.

FIG. 16 shows the detection of interactions within 48 peptide pairs corresponding to the embodiment shown in FIG. 7 with overlapping dodecapeptides representing the FKBP12-sequence and the peptides derived from the cytoplasmatic domain of EGF-receptors, whereby the peptides interact with FKBP12.

The cellulose modified with peptide pairs by molecular forks MG2 was analyzed using 200 nM FKBP12 followed by the Western Blot-analysis and immunodetection. The constant peptide block acetyl-PHVCRLLGICLTS of the EGF-receptor (Pro748-Ser760) was synthesized at the Dde-side. At the Fmoc-side, overlapping 13 mer peptides were synthesized covering the whole FKPB12-sequence with a 2-amino acid shift. The densitometric analysis was performed using a GS-700 imaging densitometer (Bio-Rad). The ordinate represents the difference from the inverse value of the intensity of each analyzed spot and the inverse value of the average spot intensity. Large positive values correspond to a weak signal in the blot and show potential interaction within a peptide pair. The region Met21-Ser67 was identified to be the interaction region in FKBP12.

FIG. 17 shows the map of streptavidine/strep-tag II interaction by 75 peptide pairs consisting of overlapping dodecapeptides representing the streptavidine-sequence and the strep-tag II-peptide. The reading of the signal by fluorescence and the inhibition of the streptavidine-peptide/strep-tag II-interactions using the natural product biotine and their derivatives are shown.

A) The chemical structure of the exemplary molecular fork MG3. B) The cellulose was modified with peptide pairs by molecular forks MG3 corresponding to the embodiments shown in FIG. 7.

The peptide being at the side of Fmoc was marked with a danysl-radical and the peptide being at the Aloc-side was marked with fluoresceine. The analysis was performed by detection of the light emission at 510-530 nm after excitation with light of a wave length of 366 nm using the Raytest DIANA chemiluminescence detection system. C) The membrane modified as described in B) was incubated for 30 min before the analysis in a solution containing 0.5 mM biotine, 1 mM 2-iminobiotine (Ka=8.0*10⁶ M⁻¹) or diaminobiotine (G. O. Reznik, S. Vajda, T. Sano, C. R. Cantor; 1998, A streptavidine mutant with altered ligand-binding specificity, Proc. Natl. Acad. Sci. USA, 95, 13525-13530).

### EXAMPLES

### Example 1

### Immobilization of Peptide Pairs by a Molecular Fork (MG1, FIG. 5) on Amino-Functionalized Cellulose Surfaces

The amino acid derivatives Fmoc-Lys(Dde)-OH and Boc-Lys (Fmoc)-OH were dissolved in 0.3 M in DMF and activated by the addition of one equivalent PyBOP in presence of DIEA (10%, v/v). Fmoc-Lys(Dde)-OH was coupled by a (β-Ala)₂ spacer of the amino-functionalized cellulose surface in DMF. The cleavage of the protecting group N^{α}-Fmoc was carried out using 20% piperidine in DMF twice for 5 min respectively 15 min at ambient temperature. Subsequently, Boc-Lys(Fmoc)-OH was coupled in DMF. The cleavage of the protecting group N^{α}-Fmoc was carried out using 20% piperidine in DMF twice for 5 min respectively 15 min at ambient temperature. Subsequently, it was washed with DMF (3×10 min) and methanol (2×5 min), and the cellulose was dried. Each first peptide chain was carried out automatically according to the standard SPOT-synthesis method with an Autospot ASP 222 device (Abimed, Langenfeld, Germany).

After termination of the synthesis of the first peptide chain, the free N-terminal amino groups were acetylated using 5% acidic anhydride/2% DIEA in DMF for 30 min. Subsequently the Dde-protecting group at the molecular Y was removed using 2% hydrazine in DMF for 3×3 min. The synthesis of the second peptide chain was automatically performed according to the standard-SPOT-synthesis method and the free N-terminal amino groups were acetylated for 30 min using 5% acidic anhydride/2% DIEA in DMF after termination of the synthesis of the second peptide chain. The cleavage of the permanent protecting groups was performed using 50% TFA/DCM with 2% triisopropylsilane and 3% water for 3 h at ambient temperature while slightly shaking. Subsequently, the cellulose was washed twice with DCM for 5 min, three times with DMF for 15 min and twice with MeOH for 10 min, dried and stored for further usage at −20° C.

### Example 2

### Immobilization of Peptide Pairs by a Molecular Fork (MG2, FIG. 6) on Amino-Functionalized Cellulose Surfaces

Firstly, the amino acid derivatives Fmoc-Lys(Dde)-OH and Fmoc-Glu(OtBu)-OH activated by PyBOP, were coupled sequentially on the Rink-amide MBHA-resin in DMF by a Fmoc-based peptide synthesis strategy (Chan, W. C. and White, P. D. 2000, Fields, G. B. and Nobel, R. L. 1990). Then Fmoc-Glu-Lys(Dde)-CONH₂ was released from the polymer using 95% TFA, 2% truisopropylsilane, 3% water for 1 h at ambient temperature. The cleaned-up Fmoc-Glu-Lys(Dde)-CONH₂ (0.3 M) was activated at the carboxylic group of Glu by 0.3 M PYBOP in DMF with DIEA (10% v/v) and coupled to the (β-Ala)₂ spacer of the amino-functionalized cellulose surface in DMF three times for 20 min each. The cleavage of the N^{α}-FMOC-protecting group was performed using 20% piperidine in DMF two times for 5 min respectively 15 min at ambient temperature. Subsequently it was washed with DMF (3×10 min) and methanol (2×5 min) and the cellulose was dried. Subsequently, the coupling (twice) of BOC-Lys(Fmoc)-OH (0.3 M) activated with 0.3 M PyBOP was carried out in DMF with DIEA (10% v/v).

The cleavage of the N^{α}-Fmoc-protecting group was performed using 20% piperidine in DMF twice for 5 min respectively 15 min at ambient temperature. Every first peptide chain was automatically carried out according to the standard-SPOT-synthesis method with the Autospot ASP 222 device (Abimed, Langenfeld, Germany).

After termination of the synthesis of the first peptide chain, the free N-terminal amino groups were acetylated using 5% acidic anhydride/2% DIEA in DMF for 30 min. Subsequently, the Dde-protecting group at the molecular fork was removed using 2% hydrazine in DMF for 3×3 min. The synthesis of the second peptide chain was automatically carried out according to the standard-SPOT-synthesis method, and after finishing the synthesis of the second peptide chain, the free N-terminal amino groups were acetylated using 5% acidic anhydride/2% DIEA in DMF for 30 min, The cleavage of the permanent protecting groups was carried out using 50% TFA/DCM with 2% triisopropylsilane and 3% water for 3 h at ambient temperature under slight shaking. Subsequently, the cellulose was dried two times for 5 min with DCM, three times for 15 min with DMF and twice for 10 min with MeOH, and stored at −20° C. for further use.

### Example 3

### Immobilization of Peptide Pairs by a Molecular Fork and Amino-Functionalized APEG-aminopolypropylen Surfaces

Fmoc-Glu-Lys(Dde)-CONH₂ was prepared as explained in example 2 and activated by PyBOP. Subsequently, the coupling to the (β-Ala)₂ spacer of the APEG-aminopolypropylen surface was carried out (AMIS Scientific Products GmbH, Germany). The further synthesis was carried out as described in example 2.

### Example 4

### Analysis of the Streptavidine/Strep-Tag II Interaction using the Molecular Fork MG1

As described in example 1, the peptide pairs were synthesized at the MG1, whereby the constant peptide block strep-tag II was synthesized at the Dde-side. At the Fmoc-side, the overlapping 12mer peptides spanning the entire streptavidine-sequence with a 3-aminoacid shift were synthesized (FIG. 8A). At the same time, the peptide pairs were synthesized as described in example 1, whereby the constant peptide block strep-tag II was synthesized at the Fmoc-side. At the Dde-side, the overlapping 12 mer peptides were synthesized overlapping the whole streptavidine-sequence with a 3-aminoacid shift (FIG. 8B). There are 50 individual spots in each case. After the synthesis, the dry cellulose modified with peptide pairs by molecular forks was washed for 10 min with MeOH and 3 times for 20 min with TBS (30 mM tris-HCl, pH 7.6, 170 mM NaCl, 6.4 mM KCl). The detection of an interaction between the peptides of a peptide pair immobilized on the molecular fork was obtained with streptavidine as detection molecule, which can not interact with interacting peptides, but, however, interacts with strep-tag II, which is not involved in a peptide-peptide-interaction.

100 nM streptavidine in a MP-buffer (30 mM tris-HCl, pH 7.6, 170 mM NaCl, 6.4 mM KCl, 0.05% Tween 20, 5% sucrose) were incubated over night at 4° C. while shaking with the cellulose. Unbound protein was removed by washing with TBS (4° C.), bound protein was electro-transferred to a nitrocellulose membrane (0.45 μM, PALL Gelman, Germany) by a semi-dry blotter (Biometra, Germany). Therefore, two nitrocellulose membranes were placed on both sides of the cellulose modified with peptide pairs by molecular forks and this array was placed between blot paper, which was soaked with a transfer-buffer (25 mM tris-HCl, pH 8.3, 150 mM glycine, 10% methanol). The electro-transfer was carried out at 0.8 mA/cm² for different times (first electro-transfer step 45 min, second electro-transfer step 90 min). The detection of streptavidine was carried out by immunodetection and visualization using the ECL-system (Amersham Pharmacia).

A densitometric analysis of the intensity of each spot was performed by a GS-700 imaging densitometer (Bio-Rad) to quantify the signals. Spots showing a bond of streptavidine contain non-interacting peptides, while spots showing no binding of streptavidine contain interacting peptides (see FIG. 8).

### Example 5

### Analysis of the Streptavidine/Strep-Tag II Interaction Using the Molecular Fork MG2

As described in example 2, peptide pairs were synthesized at MG2, whereby the constant peptide block strep-tag II was synthesized at the Dde-side. At the Fmoc-side, overlapping 12 mer peptides were synthesized spanning the entire streptavidine-sequence with a 2-aminoacid shift. 75 individual spots resulted therefrom. After the synthesis, the dry cellulose modified with peptide pairs by molecular forks was washed for 10 min with MeOH and 3 times for 20 min with TBS (30 mM tris-HCl, pH 7.6, 170 mM NaCl, 6.4 mM KCl). The detection of an interaction between the peptides of a peptide pair immobilized on the molecular fork was obtained with streptavidine as detection molecule, which does not interact with interacting peptides, but which interacts with strep-tag II, which is not involved in a peptide-peptide-interaction. 100 mM streptavidine were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing with TBS (4° C.), bound protein was electro-transferred to a nitrocellulose membrane (0.45 μM, PALL Gelman, Germany) using a semi-dry blotter (Biometra, Germany). Therefore, two nitrocellulose membranes were placed on both sides of cellulose modified with peptide pairs by molecular forks, and this array was spaced between blot paper, which was soaked with transfer buffer (25 mM tris-HCl, pH 8.3, 150 mM glycine, 10% methanol). The electro-transfer was carried out at 0.8 mA/cm² for different times (first electro-transfer step 45 min, second electro transfer step 90 min) The detection of streptavidine was performed using immunodetection and visualization using the ECL-system (Amersham Pharmacia).

A densitometric analysis of the intensities of each spot was performed by a GS-700 imaging densitometer (Bio-Rad) for quantifying the signals. Spots detecting bonds of streptavidine contain non-interacting peptides, while spots, where no binding of streptavidine was detected, contain interacting peptides (see FIG. 9).

In an analogous way, the streptavidine/strep-tag II interaction was analyzed by immobilization of peptide pairs by MG2 on amino-functionalized APEG-aminopolypropylen surfaces (FIG. 10).

### Example 6

### Mapping the Length of Streptavidine/Strep-Tag II Interaction Domains Using the Molecular Fork MG2

As described in example 2, peptide pairs were synthesized at MG2, whereby the constant peptide block strep-tag II was synthesized at the Dde-side. At the Fmoc-side, 6 mer to 12 mer peptides were synthesized spanning the sequence of the streptavidine fragment Arg59-Ala¹⁰⁰ with a 2-aminoacid shift. After the synthesis, the dry cellulose modified with peptide pairs by molecular forks was washed for 10 min with MeOH and 3 times with TBS for 20 min (30 mM tris-HCl, pH 7.6, 170 mM NaCl, 6.4 mM KCl). The detection of an interaction between peptides of peptide pairs immobilized on the molecular fork was obtained with streptavidine as detection molecule, which does not interact with interacting peptides, but which interacts with strep-tag II, which is not involved in a peptide-peptide-interaction.

50 nM streptavidine were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing with TBS (4° C.), bound protein was electro-transferred to a nitrocellulose membrane (0.45 μM, PALL Gelman, Germany) by a semi-dry blotter (Biometra, Germany). Therefore, two nitrocellulose membranes were placed on both sides of the cellulose modified with peptide pairs by molecular forks, and this array was placed between blot paper, which was soaked with transfer buffer (25 mM tris-HCl, pH 8.3, 150 mM glycine, 10% methanol). The electro-transfer was performed at 0.8 mA/cm² for different times (first electro-transfer step 45 min, second electro-transfer step 90 min). The detection of streptavidine was performed by immuno-detection and visualization using the ECL-system (Amersham Pharmacia).

A densitometric analysis of the intensities of each spot was performed by a GS-700 imaging densitometer (Bio-Rad) for quantifying the signals. Spots detecting bonds of streptavidine contain non-interacting peptides, while spots, where no binding of streptavidine was detected, contain interacting peptides (see FIG. 11).

### Example 7

### Analysis of the Streptavidine/Strep-Tag II Interaction Using the Inhibition with Biotine

As described in example 2, peptide pairs were synthesized at the MG2, whereby the constant peptide block strep-tag II was synthesized at the Dde-side. At the Fmoc-side, overlapping 12 mer peptides were synthesized spanning the entire streptavidine-sequence with a 2-aminoacid shift. 60 μg streptavidine were pre-incubated using 6 μg biotine in the MP-buffer (30 mM tris-HCl, pH 7.6, 170 mM NaCl, 6.4 mM KCl, 0.05% Tween 20, 5% sucrose) for 60 min and it was subsequently incubated overnight at 4° C. while shaking with the cellulose.

Unbound protein was removed by washing with TBS (4° C.), bound protein was electro-transferred to a nitrocellulose membrane (0.45 μM, PALL Gelman, Germany) via a semi-dry blotter (Biometra, Germany). Therefore, two nitrocellulose membranes were placed on both sides of the cellulose modified with peptide pairs by molecular forks, and this array was placed between blot paper, which was soaked with transfer buffer (25 mM tris-HCl, pH 8.3, 150 mM glycine, 10% methanol). The electro-transfer was performed at 0.8 mA/cm² for different times (first electro-transfer step 45 min, second electro-transfer step 90 min). The detection of streptavidine was performed by immuno-detection and visualization using the ECL-system (Amersham Pharmacia).

A densitometric analysis of the intensities of each spot was performed by a GS-700 imaging densitometer (Bio-Rad) for quantifying the signals (FIG. 12).

### Example 8

### Mapping the Interaction Sites of the Raf-Peptides RQRSTpSTPNV at the 14-4-4 Protein

As described in example 2, peptide pairs were synthesized to the MG2, whereby the constant peptide block RQRSTpSTPNV (Raf-peptide) was synthesized to the Dde-side. On the Fmoc-side overlapping 12 mere peptides were synthesized covering the whole 14-3-3-sequence with a 3-aminoacid shift. 80 individual spots resulted therefrom. After the synthesis, the dry cellulose modified with peptide pairs by molecular forks was washed for 10 min with MeOH and 3 times for 20 min with TBS (30 mM tris-HCl, pH 7.6, 170 mM NaCl, 6.4 mM KCl). The detection of an interaction between the peptides of a peptide pair immobilized on a molecular fork was performed by 14-3-3 ξ/δ as detecting molecule which does not interact with interacting peptides, which however interacts with a Raf-peptide, which is not involved in a peptide-peptide-interaction.

150 nM of a 14-3-3 protein were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing with TBS (4° C.), bound protein was electro-transferred on nitrocellulose membranes (0.45 μM, PALL Gelman, Germany) via a semi-dry blotter (Biometra, Germany). Therefore, two nitrocellulose membranes were placed on both sides on the cellulose modified with peptide pairs by molecular forks, and this array was placed between blot paper, which was soaked with transfer buffer (25 μM tris-HCl, pH 8.3, 150 mM glycine, 10& methanol), The electro-transfer was performed at 0.8 mA/cm² for different times (first electro-transfer step 45 min, second electro-transfer step 90 min). The detection of 14-3-3 protein was performed via immunodetection and visualization via the ECL-system (Amersham Pharmacia).

A densitometric analysis of the intensity of each spot was performed for quantification of the signals using a GS-700 imaging densitometer (Bio-Rad). Spots detecting a bond of 14-3-3 protein do not contain interacting peptides, while spots, where a bond of 14-3-3 protein was not detected, contain interacting peptides (see FIG. 13).

### Example 9

### Mapping the Interaction Site of ARSHpSYPA (mT Peptide) at 14-3-3 Protein

As described in example 2, peptide pairs were synthesized to MG2, whereby the constant peptide block ARSHpSYPA (mT-peptide) was synthesized at the Dde-side. At the Fmoc-side, overlapping 10 mer peptides were synthesized spanning the entire 14-3-3 sequence with a 2-aminoacid shift. 120 individual spots resulted therefrom. After the synthesis, the dry cellulose modified with peptide pairs by a molecular fork were washed for 10 min with MeOH and 3 times for 20 min with TBS (30 mM tris-HCl, pH 7.6, 170 mM NaCl, 6.4 mM KCl). The detection of an interaction between the peptides and a peptide pair immobilized to the molecular Y was carried out with 14-3-3 ξ/δ as detection molecule, which does not interact with interacting peptides, but which however interacts with mT peptide, which is not involved in a peptide-peptide-interaction.

200 nM of a 14-3-3 protein were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing TBS (4° C.), bound protein was electro-transferred on a nitrocellulose membrane (0.45 μM, PALL Gelman, Germany) by a semi-dry blotter (Biometra, Germany). Therefore, two nitrocellulose membranes were placed on both sides of the peptide modified with peptide pairs by molecular forks and the array was placed between blot paper, which was soaked with transfer buffer (25 mM tris-HCl, pH 8.3, 150 mM glycine, 10% methanol). The electro-transfer was performed at 0.8 mA/cm² for different times (first electro-transfer step 45 min, second electro transfer step 90 min). The detection of the 14-3-3 protein was performed by immunodetection and visualization using the ECL-system (Amersham Pharmacia).

A densitometric analysis of the intensity of each spot was carried out for the quantification of the signals using a GS-700 imaging densitometer (Bio-Rad). Spots detecting a bond of 14-3-3 ξ/δ contain non-interacting peptides, while spots, where no bond of the 14-3-3 protein was detected, contain interacting peptides (see FIG. 14).

### Example 10

### Analysis of the FKBP12/FAP48 Interaction

In a first step, the FKBP12-binding sites in the FAP48 were mapped using classical SPOT-technology and protein interaction analysis. Two sequence domains were found in FAP48, which mediate an interaction to FKBP12, FAP48 Lys217-Ser229 (KCPLLTAQFFEQS) and FAP48 Leu307-His319 (LSPLYLLQFNMGH).

Subsequently, peptide pairs were synthesized to the MG2, as described in example 2, whereby the constant peptide blocks Ac-KCPLLTAQFFEQS respectively AC-LSPLYLLQFNMGH were synthesized at the Dde-side. At the Fmoc-side, overlapping 13 mer peptides were synthesized spanning the entire FKBP12-sequence with a 2-aminoacid shift. In each case, 48 individual spots resulted therefrom.

After the synthesis, the dry cellulose modified with peptide pairs by molecular forks were washed for 10 min with MeOH and 3 times with TBS for 20 min (30 mM tris-HCl, pH 7.6, 170 mM NaCl, 6.4 mM KCl). The detection of an interaction between the peptides of peptide pairs immobilized to the molecular fork was obtained with FKBP12 as detection molecule, which may not interact with interacting peptides, but however interacts with the corresponding FAP48-peptide, which is not involved in a peptide-peptide-interaction.

200 nM FKBP12 were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing with TBS (4° C.), bound protein was electro-transferred on nitrocellulose membranes (0.45 μM, PALL Gelman, Germany) by a semi-dry blotter (Biometra, Germany). Two nitrocellulose membranes were placed on both sides of the cellulose modified with peptide pairs by molecular forks and the array was placed between blot paper, which was soaked with transfer buffer (25 mM tris-HCl, pH 8.3, 150 mM glycine, 10% methanol). The electro-transfer was performed at 0.8 mA/cm² for different times (first electro-transfer step 45 min, second electro-transfer step 90 min). The detection of FKBP12 was performed by immunodetection and visualization using the ECL-system (Amersham Pharmacia).

A densitometric analysis of the synthesis of each spot was performed using a GS-700 imaging densitometer (Bio-Rad) for the quantification of the signals. Spots detecting a bond to the FKBP12 contain non-interacting peptides, while spots, where no bond of FKBP12 was detected, contain interacting peptides (see FIGS. 15A and 15B).

### Example 11

### Analysis of the Interactions Between FKBP12 and the Cytosolic Domain of the EGF-Receptor (Aminoacid Radical 645-1186)

In a first step, the FKBP12 binding sites in the cytosolic domain of the EGF-receptor (EGFR) were mapped by classical SPOT-technology and protein interaction analysis. Five sequence domains were found in the EGFR, which mediate an interaction to FKBP12. Among these sequence domains, the sequence of a particularly strong interacting peptide, namely PHVCRLLGICLTS (EGFR Pro⁷⁴⁸-Ser⁷⁶⁰) was selected using. Then, peptide pairs were synthesized at the MG12, as described in example 2, whereby the constant peptide block Ac-PHVCRLLGICLTS was synthesized at the Dde-side. At the Fmoc-side, overlapping 13 mer peptides were synthesized spanning the entwire FKBP12-sequence with a 2-aminoacid shift. In each case 48 individual spots resulted therefrom.

After the synthesis, the dry cellulose modified with peptide pairs by molecular forks was washed for 10 min with MeOH and 3 times with TBS for 20 min (30 mM tris-HCl, pH 7.6, 170 mM NaCl, 6.4 mM KC). The detection of an interaction between the peptides of a peptide pair immobilized at the molecular Y was obtained with FKBP12 as detection molecule, which does not interact with interacting peptides, which however interacts with the corresponding EGFR-peptide, which is not involved in a peptide-peptide-interaction.

200 nM FKBP12 were incubated in a MP-buffer (30 mM tris-HCl, pH 7.6, 170 mM NaCl, 6.4 mM KCl, 0.05% Tween 20, 5% sucrose) overnight at 4° C. while shaking with the cellulose. Unbound protein was removed by washing with TBS (4° C.), bound protein was electro-transferred on nitrocellulose membranes (0.45 μM, PALL Gelman, Germany) by a semi-dry blotter (Biometra, Germany). Therefore, two nitrocellulose membranes were placed on both sides of the cellulose modified with peptide pairs by molecular forks and this array was placed between blot paper, which was soaked with transfer buffer (25 mM tris-HCl, pH 8.3, 150 mM glycine, 10% methanol). The electro-transfer was performed at 0.8 mA/cm² for different times (first electro-transfer step 45 min, second electro-transfer step 90 min). The detection of FKBP12 was carried out by immunodetection and visualization using the ECL-system (Amersham Pharmacia).

A densitometric analysis of the intensity of each spot was performed for quantification of the signals by a GS-700 imaging densitometer (Bio-Rad). Spots showing a binding of FKBP12 contain non-interacting peptides, while spots showing no binding of FKBP12 contain interacting peptides (see FIG. 16).

### Example 12

### Inhibition of Streptavidine-Peptide/Strep-Tag II Interactions Using Biotine and/or its Derivatives

Peptide pairs were synthesized at MG3 (FIG. 17A), whereby the constant peptide block strep-tag II was synthesized at the Aloc-side and marked with a fluoresceine radical. At the Fmoc-side, overlapping 12 mer peptides were synthesized spanning the entire streptavidine-sequence with a 2-aminoacid shift, and were marked with a dansyl radical. 75 individual spots resulted in each case. After the synthesis, the dry cellulose modified with peptide pairs by molecular forks was washed for 10 min with MeOH and 3 times with TBS for 20 min (30 mM tris-HCl, pH 7.6, 170 mM NaCl, 6.4 mM KCl). The analysis was performed by detection of the emitted light at 510-530 nm after excitation with light of a wavelength of 366 nm by the Raytest DIANA chemiluminescence detection system (FIG. 17B). Differences in fluorescence properties of the spots were obtained with different peptide pairs, an enhanced fluorescence emission was detected for interacting peptide pairs.

For the inhibition of interaction of the peptide pairs, the modified membrane was treated with high-affinated, low-affine and non-affine agents with similar chemical properties before the analysis. In this example, the incubation was performed for 30 min in a solution containing 0.5 mM biotine, 1 mM 2-iminobiotine (Ka=8.0*10⁶ M⁻¹) respectively diaminobiotine (G. O. Reznik, S. Vajda, T. Sano, C. R. Cantor; 1998, A streptavidine mutant with altered ligand-binding specificity, Proc. Natl. Acad. Sci. USA, 95, 13525-13530) (FIG. 17C). After the treatment with a pharmaceutical agent, the cellulose was regenerated by treatment with a buffer A (urea 48 g, SDS 1 g, mercaptoethanol 100 μl, water filled up to 100 ml) and buffer B (water 40 ml, EtOH 50 ml, acidic acid 10 ml). Subsequently, the analysis of the fluorescence properties of the spots was carried out. The fluorescence emission of the spots was decreased in presence of a high-affine inhibitor biotine, all spots showed a very similar fluorescence behaviour. In presence of the low-affine diaminobiotine, the fluorescence behaviour was very similar to the original fluorescence behaviour without a pharmaceutical agent. This shows that an inhibition of an interaction took place in presence of a high-affine pharmaceutical agent but not in presence of a low-affine pharmaceutical agent (see FIG. 17).

1. Device for the analysis of interactions between biomolecules comprising a support on which a plurality of biomolecules are immobilized in the form of an regular or irregular array by a linker on the surface of the support characterized in that two biomolecules are bound to each linker.

2. Device according to claim 1, characterized in that the linker has an essentially fork-like structure.

3. Device according to claim 2, characterized in that the linker contains three reactive groups.

4. Device according to claim 3, characterized in that the linker is covalently bound to the surface of the support by a reactive group.

5. Device according to claim 1, characterized in that the biomolecules are biopolymers.

6. Device according to claim 5, characterized in that the biopolymers consist of sequences of monomer units.

7. Device according to claim 6, characterized in that the biopolymers are selected from the group consisting of terpenes, nucleic acid sequences, carbohydrate sequences, amino acid sequences and peptide glycoconjugate sequences.

8. Device according to claim 6, characterized in that the biopolymer sequences bound to a linker are arranged in a defined distance to one another by means of a spacer.

9. Device according to claim 8, characterized in that the support material is selected from the group consisting of glass, ceramics, metals and their alloys, cellulose, chitin and synthetic polymers.

10. Method for the detection of interactions between biopolymers immobilized on a surface, comprising the steps:
a) Providing a device according to one of the preceding claims,
b) adjusting a defined distance between two different bio-polymers immobilized on the surface,
c) detecting a signal generated by the interaction between the two different biopolymers.

11. Method according to claim 10, characterized in that the immobilized biopolymers are consisting of sequences of monomer units selected from the group consisting of terpenes, nucleic acid sequences, carbohydrate sequences, amino acid sequences and peptide glycoconjugate sequences.

12. Method according to claim 11, characterized in that the immobilized biopolymers are contacted before step c) with a further molecule, which is capable to distinguish between interacting immobilized biopolymers and non-interacting immobilized biopolymers.

13. Method according to claim 12, characterized in that the further molecule is selected from the group consisting of proteins, antibodies and lectins.

14. Method according to claim 10, characterized in that the detection of the interaction between the immobilized biopolymers is carried out by a method indicating the presence of the further molecule.

15. Method according to claim 14, characterized in that the method is selected from the group consisting of autoradiography, plasmonresonance spectroscopy, immunology and fluorescence spectroscopy.

16. Method according to claim 10, characterized in that the detection of the interaction is performed directly by a detection method, which is capable to distinguish between interacting immobilized biopolymers and non-interacting immobilized biopolymers.

17. Method according to claim 16, characterized in that the detection method results in different signals for different distances between interacting immobilized biopolymers and non-interacting immobilized biopolymers.

18. Method according to claim 17, characterized in that the method is selected from the group consisting of nuclear magnetic resonance spectroscopy, electron-spin-resonance spectroscopy, CD-spectroscopy, mass-spectrometry, FT-infrared-spectroscopy and fluorescence-spectroscopy.

19. Method according to claim 16, characterized in that an auxiliary compound is added before the detection of the interaction.

20. Method according to claim 19, characterized in that the auxiliary component is a deuterated compound.

21. Method according to claim 20, characterized in that the detection indicates the change of the exchange rate of amide deuterons.

22. Method according to claim 21, characterized in that the detection is performed by a method selected from the group consisting of MALDI-mass-spectrometry, ESI-mass-spectrometry and NMR-spectroscopy.

23. Method according to claim 19, characterized in that amino acid sequence groups are selectively irradiated with light of appropriate frequency and intensity before the detection of the interaction of immobilized biopolymers, whereby a covalent bond results between the interacting amino acid sequences.

24. Method according to claim 23, characterized in that the detection of the interaction is carried out by a method selected from the group consisting of MALDI-mass-spectrometry, ESI-mass-spectrometry and NMR-spectroscopy.

25. Method according to claim 1, characterized in that the immobilized biopolymers are contacted with an agent before step c).

26. Method according to claim 25, characterized in that the agent is selected from the group consisting of pharmaceutical agents, potential pharmaceutical agents, organic molecules and natural materials.


SEQUENCE LISTING (35 sequences)

SEQ ID NO: 1 - protein, 10 aa, Artificial Sequence
  MOD_RES (6): Phosphoserine
RQRSTSTPNV

SEQ ID NO: 2 - protein, 8 aa, Artificial Sequence
  MOD_RES (5): Phosphoserine
ARSHSYPA

SEQ ID NO: 3 - protein, 13 aa, Artificial Sequence
  Description of Artificial Sequence Synthetic peptide
KCPLLTAQFFEQS

SEQ ID NO: 4 - protein, 13 aa, Artificial Sequence
  Description of Artificial Sequence Synthetic peptide
LSPLYLLQFNMGH

SEQ ID NO: 5 - protein, 13 aa, Artificial Sequence
  Description of Artificial Sequence Synthetic peptide
PHVCRLLGICLTS

SEQ ID NO: 6 - protein, 15 aa, Artificial Sequence
  Description of Artificial Sequence Synthetic peptide
NAESRYVLTGRYDSA

SEQ ID NO: 7 - protein, 18 aa, Artificial Sequence
  Description of Artificial Sequence Synthetic peptide
LGWTVAWKNNYRNAHSAT

SEQ ID NO: 8 - protein, 16 aa, Artificial Sequence
  Description of Artificial Sequence Synthetic peptide
SAVGNAESRYVLTGRY

SEQ ID NO: 9 - protein, 26 aa, Artificial Sequence
  Description of Artificial Sequence Synthetic peptide
SGTALGWTVAWKNNYRNAHSATTWSG

SEQ ID NO: 10 - protein, 16 aa, Artificial Sequence
  Description of Artificial Sequence Synthetic peptide
GTWYNQLGSTFIVTAG

SEQ ID NO: 11 - protein, 14 aa, Artificial Sequence
  Description of Artificial Sequence Synthetic peptide
EARINTQWLLTSGT

SEQ ID NO: 12 - protein, 18 aa, Artificial Sequence
  Description of Artificial Sequence Synthetic peptide
TSGTTEANAWKSTLVGHD

SEQ ID NO: 13 - protein, 24 aa, Artificial Sequence
  Description of Artificial Sequence Synthetic peptide
SGTALGWTVAWKNNYRNAHSATTW

SEQ ID NO: 14 - protein, 34 aa, Artificial Sequence
  Description of Artificial Sequence Synthetic peptide
HDTFTKVKPSAASIPSAASIDAAKKAGVNNGNPL

SEQ ID NO: 15 - protein, 23 aa, Artificial Sequence
  Description of Artificial Sequence Synthetic peptide
TALGWTVAWKNNYRNAHSATTWS

SEQ ID NO: 16 - protein, 22 aa, Artificial Sequence
  Description of Artificial Sequence Synthetic peptide
TALGWTVAWKNNYRNAHSATTW

SEQ ID NO: 17 - protein, 19 aa, Artificial Sequence
  Description of Artificial Sequence Synthetic peptide
LGWTVAWKNNYRNAHSATT

SEQ ID NO: 18 - protein, 14 aa, Artificial Sequence
  Description of Artificial Sequence Synthetic peptide
VAWKNNYRNAHSAT

SEQ ID NO: 19 - protein, 15 aa, Artificial Sequence
  Description of Artificial Sequence Synthetic peptide
WTVAWKNNYRNAHSA

SEQ ID NO: 20 - protein, 14 aa, Artificial Sequence
  Description of Artificial Sequence Synthetic peptide
WTVAWKNNYRNAHS

SEQ ID NO: 21 - protein, 18 aa, Artificial Sequence
  Description of Artificial Sequence Synthetic peptide
AYKNVVGARRSSWRVVSS

SEQ ID NO: 22 - protein, 18 aa, Artificial Sequence
  Description of Artificial Sequence Synthetic peptide
FDEALAELDTLSEESYKD

SEQ ID NO: 23 - protein, 18 aa, Artificial Sequence
  Description of Artificial Sequence Synthetic peptide
TLWTSDTQGDEAEAGEGG

SEQ ID NO: 24 - protein, 24 aa, Artificial Sequence
  Description of Artificial Sequence Synthetic peptide
ERYDDMAACMKSVTEQGAELSNEE

SEQ ID NO: 25 - protein, 18 aa, Artificial Sequence
  Description of Artificial Sequence Synthetic peptide
QAESKVFYLKMKGDYYRY

SEQ ID NO: 26 - protein, 14 aa, Artificial Sequence
  Description of Artificial Sequence Synthetic peptide
PEKACSLAKTAFDE

SEQ ID NO: 27 - protein, 16 aa, Artificial Sequence
  Description of Artificial Sequence Synthetic peptide
AFDEAIAELDTLSEES

SEQ ID NO: 28 - protein, 18 aa, Artificial Sequence
  Description of Artificial Sequence Synthetic peptide
LWTSDTQGDEAEAGEGGE

SEQ ID NO: 29 - protein, 34 aa, Artificial Sequence
  Description of Artificial Sequence Synthetic peptide
MLEDGKKFDSSRDRNKPFKFTLGKQEVIRGWEEG

SEQ ID NO: 30 - protein, 38 aa, Artificial Sequence
  Description of Artificial Sequence Synthetic peptide
HYTGMLEDGKKFDSSRDRNKPFKFTLGKQEVIRGWEEG

SEQ ID NO: 31 - protein, 18 aa, Artificial Sequence
  Description of Artificial Sequence Synthetic peptide
WYNQLGSTFIVTAGADGA

SEQ ID NO: 32 - protein, 32 aa, Artificial Sequence
  Description of Artificial Sequence Synthetic peptide
ADGALTGTYESAVGNAESRYVLTGRYDSAPAT

SEQ ID NO: 33 - protein, 16 aa, Artificial Sequence
  Description of Artificial Sequence Synthetic peptide
DGSGTALGWTVAWKNN

SEQ ID NO: 34 - protein, 36 aa, Artificial Sequence
  Description of Artificial Sequence Synthetic peptide
NAHSATTWSGQYVGGAEARINTQWLLTSGTTEANAW

SEQ ID NO: 35 - protein, 22 aa, Artificial Sequence
  Description of Artificial Sequence Synthetic peptide
VKPSAASIDAAKKAGVNNGNPL